(19) United States
(12) Patent Application Publication
(10) Pub. No.: US 2026/0207416 A1
(43) Pub. Date: Jul. 23, 2026

(54) COMPRESSION GARMENT SYSTEMS

(71) Applicant: TACTILE SYSTEMS TECHNOLOGY, INC., Minneapolis, MN (US)

(72) Inventors: Ryan Staab, Minneapolis, MN (US); Travis Christensen, Circle Pines, MN (US); Karl Zgoda, Tucson, AZ (US)

(21) Appl. No.: 19/029,015

(22) Filed: Jan. 17, 2025

(51) Int. Cl. A61H 9/00

(52) U.S. Cl. CPC A61H 9/0078; A61H 2201/165; A61H 2201/5002; A61H 2201/5071

(57) ABSTRACT

Compression therapy systems, devices, and methods described herein may be configured to provide compression therapy where two or more cells providing compression to distal region of a body portion may operate using a first pressure, and subsequently a second pressure. The second pressure may be reduced, or less than, the first pressure.

The present disclosure relates generally to compression garment systems and methods for delivering fluid to inflatable cells of a compression garment, and more particularly to compression garment systems and methods for inflating and deflating one or more cells of the compression garment in a variety of sequences.

Various types of compression garments are available, for example, such as for treatment of lymphedema, edema, wound healing, etc. For example, compression garments may include inflatable chambers or cells (or other actuatable elements) to provide compression therapy to patients and may be positioned about any body portion of a person or animal. Specifically, the compression garments may be positioned about body portions that exhibit swelling due to a build-up of lymph and/or other fluid and that would benefit from compression therapy provided by the compression garments. For example, such inflatable chambers or cells may be inflatable to one or more different pressures in a variety of sequences to provide compression therapy to the patient by moving lymph from one body region to another. In other words, such compression garments may be placed about at least a portion of an individual's body for use in applying pressure to the body at one or more body regions (such as, e.g., an affected extremity). These compression garments may be donned (e.g., put on) and doffed (e.g., taken off or removed) by patients themselves or with help from others.

### SUMMARY

Illustrative compression systems and methods may include one or more ways to fill the inflatable cells of compression garment to provide compression therapy to one or more body portions that the compression garment is donned thereabout. A user may wear the compression garment about a limb such as a leg. The compression garment may be configured to gradually move lymph fluid from a distal end of the leg (e.g., the foot) up to a proximal end of the leg (e.g., the waist) by sequentially applying pressure at a number of points along the leg starting at the distal end and ending at the proximal end. However, sustained pressure on the distal end of the leg may be uncomfortable for the user. Furthermore, it may be unnecessary to maintain the pressure originally applied at the distal end for the entire duration of compression treatment. The present disclosure provides various approaches for compression therapy for limbs that do not require sustained, relatively high, pressures at the distal end of the limb.

Further, it may be advantageous to provide a compression therapy that applies pressure at two, three or more points along the leg, and then sequentially applies pressure beginning at each of the two, three, or more points so that there is a multi-wave pattern of pressure application moving towards the proximal end. Such a multi-wave pattern may advantageously reduce system complexity because the air pressure source does not need to be connected to each inflatable cell of the compression garment via individual airflow lines. Instead, one airflow line may branch into two, three, or more inflatable cells. Control of the air pressure source can be simplified since there are less individual airflow lines. The present disclosure provides various approaches for compression therapy for limbs that use multi-wave compression therapy.

In one or more embodiments, a therapeutic compression system may include a compression therapy apparatus operably couplable to a compression garment to provide compression therapy to a patient. The compression garment may include a plurality of independently inflatable cells arranged to provide the compression therapy to a limb of the patient. The plurality of independently inflatable cells may include a distal cell and a plurality of proximal cells arranged proximally to the distal cell. The therapeutic compression system may further include a controller including one or more processors and operably coupled to the compression therapy apparatus. The controller may be configured to cause the compression therapy apparatus to inflate the distal cell and at least one of the plurality of proximal cells to a first pressure during a first period of time. The at least one of the plurality of proximal cells inflated to the first pressure during the first period of time may not be positioned adjacent the distal cell. The controller may be further configured to cause the compression therapy apparatus to inflate another at least two of the plurality of proximal cells to the first pressure during a second period of time following expiration of the first period of time. At least one of the at least two of the plurality of proximal cells inflated to the first pressure during the second period of time may be positioned either adjacent the distal cell or adjacent at least one of the at least one of the plurality of proximal cells inflated to the first pressure during the first period of time. The controller may be further configured to cause the compression therapy apparatus to inflate each of the distal cell and the at least one of the plurality of proximal cells previously inflated to the first pressure during the first period of time to a second pressure during the second period of time.

In one or more embodiments, a therapeutic compression method to provide compression therapy to a patient may include inflating a distal cell and at least one of a plurality of proximal cells of a compression garment including a plurality of independent inflatable cells to a first pressure during a first period of time. The at least one of the plurality of proximal cells inflated to the first pressure during the first period of time may not be positioned adjacent the distal cell. The plurality of proximal cells may be arranged proximally to the distal cell. The method may further include inflating another at least two of the plurality of proximal cells to the first pressure during a second period of time following expiration of the first period of time. The method may further include inflating each of the distal cell and the at least one of the plurality of proximal cells previously inflated to a first pressure during the first period of time to a second pressure during the second period of time.

In one or more embodiments, a therapeutic compression system may include a compression therapy apparatus operably couplable to a compression garment to provide compression therapy to a patient. The compression garment may include a plurality of independently inflatable cells arranged to provide the compression therapy to a limb of the patient. The plurality of independently inflatable cells may include a distal cell and a plurality of proximal cells arranged proximally to the distal cell. The compression garment may further include a controller including one or more processors and operably coupled to the compression therapy apparatus. The controller may be configured to cause the compression therapy apparatus to inflate the distal cell and at least two of the plurality of proximal cells to a first pressure during a first period of time. Each of the at least two of the plurality of proximal cells inflated to the first pressure during the first period of time may not be positioned adjacent the distal cell or one another. The controller may be further configured to cause the compression therapy apparatus to inflate another at least three of the plurality of proximal cells to the first pressure during a second period of time following expiration of the first period of time. At least one of the at least three of the plurality of proximal cells inflated to the first pressure during the second period of time may be positioned either adjacent the distal cell or adjacent one of the at least two of the plurality of proximal cells inflated to the first pressure during the first period of time. The controller may be further configured to cause the compression therapy apparatus to inflate each of the distal cell and the at least two of the plurality of proximal cells previously inflated to the first pressure during the first period of time to a second pressure during the second period of time.

The above summary is not intended to describe each embodiment or every implementation of the present disclosure. A more complete understanding will become apparent and appreciated by referring to the following detailed description and claims taken in conjunction with the accompanying drawings.

### BRIEF DESCRIPTION OF THE DRAWINGS

FIG. 1 depicts an illustrative compression therapy system including a compression garment according to some embodiments.

FIG. 2 depicts an illustrative embodiment of a controller of FIG. 1.

FIG. 3A depicts an illustrative compression therapy protocol or pattern for a compression garment.

FIG. 3B depicts an illustrative compression therapy protocol or pattern for a compression garment.

FIG. 3C depicts an illustrative compression therapy protocol or pattern for a compression garment.

FIG. 3D depicts an illustrative compression therapy protocol or pattern for a compression garment.

FIG. 4 depicts an illustrative compression therapy system including a compression garment according to some embodiments.

FIG. 5A depicts an illustrative compression therapy protocol or pattern for a compression garment.

FIG. 5B depicts an illustrative compression therapy protocol or pattern for a compression garment.

FIG. 5C depicts an illustrative compression therapy protocol or pattern for a compression garment.

FIG. 5D depicts an illustrative compression therapy protocol or pattern for a compression garment.

FIG. 5E depicts an illustrative compression therapy protocol or pattern for a compression garment.

### DETAILED DESCRIPTION

In the following detailed description of illustrative embodiments, reference is made to the accompanying figures of the drawing, which form a part hereof, and in which are shown, by way of illustration, specific embodiments which may be practiced. It is to be understood that other embodiments may be utilized and structural changes may be made without departing from (e.g., still falling within) the scope of the disclosure presented hereby.

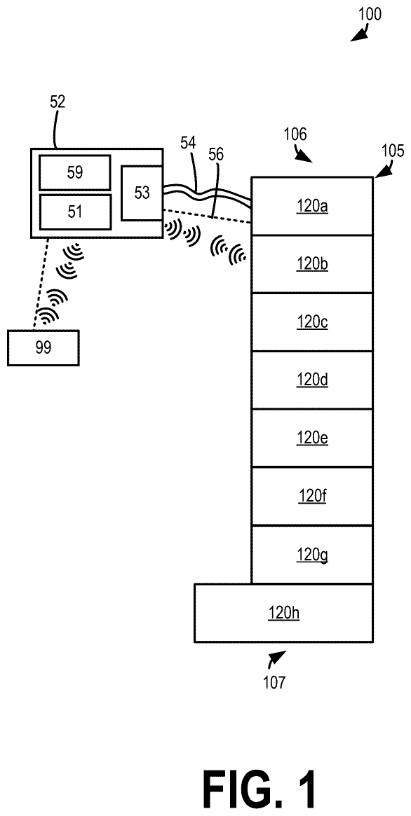

Illustrative apparatus, systems, structures, and methods shall be described with reference to FIGS. 1-5. It will be apparent to one skilled in the art that elements from one embodiment may be used in combination with elements of the other embodiments, and that the possible embodiments of such apparatus, systems, structures, and methods using combinations of features set forth herein is not limited to the specific embodiments shown in the figures and described herein. Further, it will be recognized that the embodiments described herein may include many elements that are not necessarily shown to scale. Still further, it will be recognized that the size and shape of various elements herein may be modified but still fall within the scope of the present disclosure, although certain one or more shapes, sizes, or types of elements may be advantageous over others.

The present disclosure relates generally to compression garments that include garment portions configured to be donned on at least a portion of a body (e.g., person, animal, etc.) and apply pressure to that portion of the body, compression garment systems that include compression garments and apparatuses for controlling pressure applied to at least a portion of a body, and methods using such compression garments and compression garment systems (e.g., methods of controlling pressure applied to the body according to one or more protocols, methods of configuring compression therapy, methods of identifying compression garments, etc.)

Compression garment systems (e.g., such as compression garments described in U.S. Pat. No. 6,179,796 entitled “Lymphedema treatment system,” U.S. Pat. No. 6,645,165 entitled “Lymphedema treatment system,” U.S. Pat. No. 6,860,862 entitled “Lymphedema Treatment System,” and U.S. Pat. No. 6,966,884 entitled “Lymphedema Treatment System,” which are herein incorporated by reference and which may modify and be modified with features described herein) may be used for various reasons including therapy for people with lymphedema, animals requiring therapy, wound therapy, etc. As used herein, the term body refers to not only humans but any other animal species that may benefit from the concepts and features described herein. These compression garments may be placed about at least a portion of an individual's body and used to apply pressure to the body at an affected extremity (e.g., leg, head, neck, arm, torso, a shoulder, etc.). Some embodiments described herein may include a compression system having a compression garment configured to be positioned on (e.g., wrapped around, wrapped about, placed adjacent, located proximate to, etc.) at least a portion of a body (e.g., trunk, leg, foot, arm, torso, shoulder, head, neck, etc.). The compression garment may also include one or more inflatable chambers (e.g., cells, compartments, sealed volumes, bladders etc.) distributed in (e.g., distributed throughout, distributed in concentric patterns “radiating” away from a central point or axis, along a length, etc.) the compression garment. The one or more inflatable chambers may be configured to receive a fluid (e.g., air, gas, liquid, etc.) to perform compression therapy.

The compression therapy provided by the compression garment systems may help to treat lymphedema. Lymphedema is a condition of localized fluid retention and tissue swelling that may be inherited, caused by cancer treatments, caused by parasitic infections, injury, etc. For example, lymphedema of the legs may cause swelling around the feet, ankles, calves, knees, thighs, etc. Compression garments described herein covering the leg and trunk may be used by an affected individual to provide a therapeutic benefit. Specifically, the compression garments may be configured to manipulate lymph nodes or vessels by applying pressure to move lymph toward more beneficial locations (e.g., toward drainage areas, away from affected regions, etc.). For example, compression therapy using the systems described herein may be performed proximate the leg, foot, and trunk regions to help treat lymphedema in the leg, foot, and trunk regions by, e.g., moving lymph upward towards the upper torso away from the foot.

The compression garments described herein may be configured to apply pressure to the affected regions of the body to apply, or deliver, compression therapy. The compression garments may include various portions. Each of the various portions may include controllable pressure applying regions. Each controllable pressure applying region may be configured to apply pressure to a specific portion or region of the body (e.g., at a specific time during a compression therapy time period). The controllable pressure applying regions may work in combination with one another to help deliver therapy by applying a sequence of pressures on the body that moves lymph in a desired direction (e.g., from the feet towards the trunk, from the trunk towards the feet, from the feet towards the calf, from the ankle towards the thigh, etc.). Such application of a sequence of pressures on the body that moves lymph may be referred to as applying dynamic pressure to the body. The sequence of pressures may be referred to as pressure gradients, e.g., from a distal region (e.g., feet, toes, ankle, etc.) to a proximal region (e.g., trunk, torso, etc.). Additionally, in some embodiments, dynamic pressure may not be applied sequentially, and instead, be applied non-sequentially as will be further described herein.

The controllable pressure applying regions of the compression garments may also apply static pressure to the body. For example, the compression garments may apply a constant pressure when a portion of the compression garment is positioned on the body over a compression therapy time period.

In one or more embodiments, the pressure (dynamic or static) may be applied to the portion of the body through one or more inflatable cells in the compression garment. The one or more inflatable cells may be configured to receive fluid. Alternately, or in combination with one or more inflatable cells, such pressures may be applied using one or more actuatable elements in the compression garment configured to apply pressure to the body (e.g., electrically controlled materials suitable to provide compression).

FIG. 1 depicts an illustrative compression therapy system 100 including a compression garment (such as a sleeve 105) according to some embodiments. As shown in FIG. 1, a compression sleeve 105 may be configured to encase a limb, such as an arm or a leg. The sleeve 105 can include a proximal opening 106 and a distal opening 107. A patient may pull the sleeve 105 over or wrap the sleeve around the limb. The patient may attach tubing 54 to a controller 52. In one nonlimiting example, a plurality of independently inflatable cells 120a-h may be arranged in the compression garment in an ordered sequence. Each of the independently inflatable cells 120a-h can be arranged adjacent to each other in the ordered sequence. In some embodiments, the independently inflatable cells 120a-h can be immediately adjacent to each other, where there is minimal separation between each individually inflatable cell. In some embodiments, the independently inflatable cells 120a-h can be adjacent to each other and separated by a seam defining each cell. The independently inflatable cells 120a-h may be arranged from a proximal cell 120a to a distal cell 120h, with a plurality of intermediate cells 120b-g disposed therebetween. The independently inflatable cells 120a-h can be arranged sequentially and adjacent to each other from the proximal opening 106 to the distal opening 107.

In one non-limiting example, the proximal cell 120a may be disposed at a proximal location of a patient, for example at a shoulder or the upper arm, and the distal cell 120h may be disposed at a distal location of the patient, for example, at a forearm or a wrist or a hand, for a compression garment (e.g., sleeve 105) used for an arm. In one non-limiting example, the compression garment may be a lower limb garment, and the proximal location of the patient may be at a hip, waist, the groin, the upper thigh, or the abdomen, and the distal cell 120h may be disposed at a distal location of the patient, for example, at a calf, an ankle, or a foot. In one non-limiting example, the compression garment may be a distal lower limb garment, and the proximal location of the patient may be at a lower calf or an ankle, and the distal cell 120h may be disposed at a distal location of the patient, for example, at a foot.

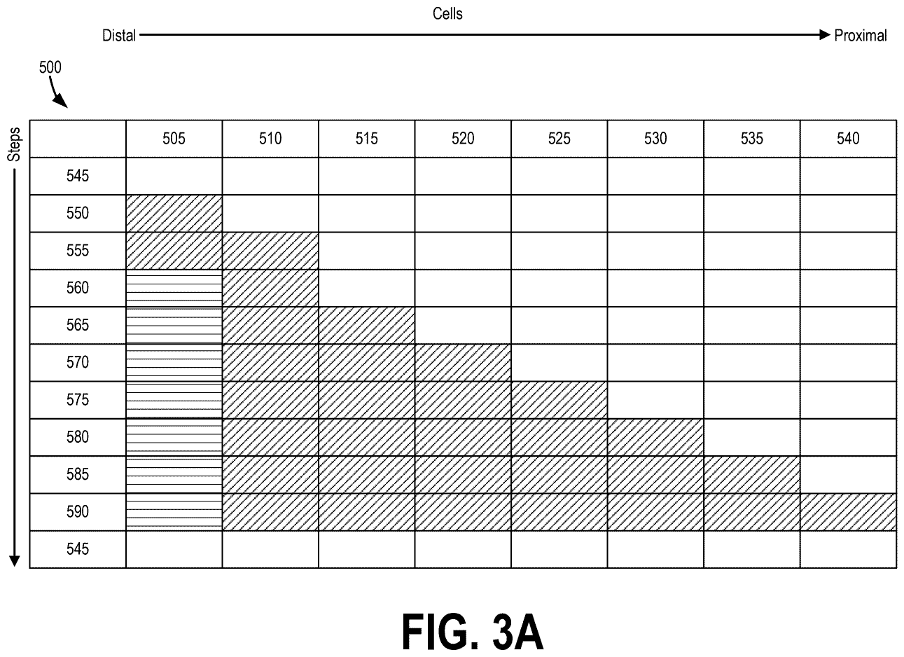

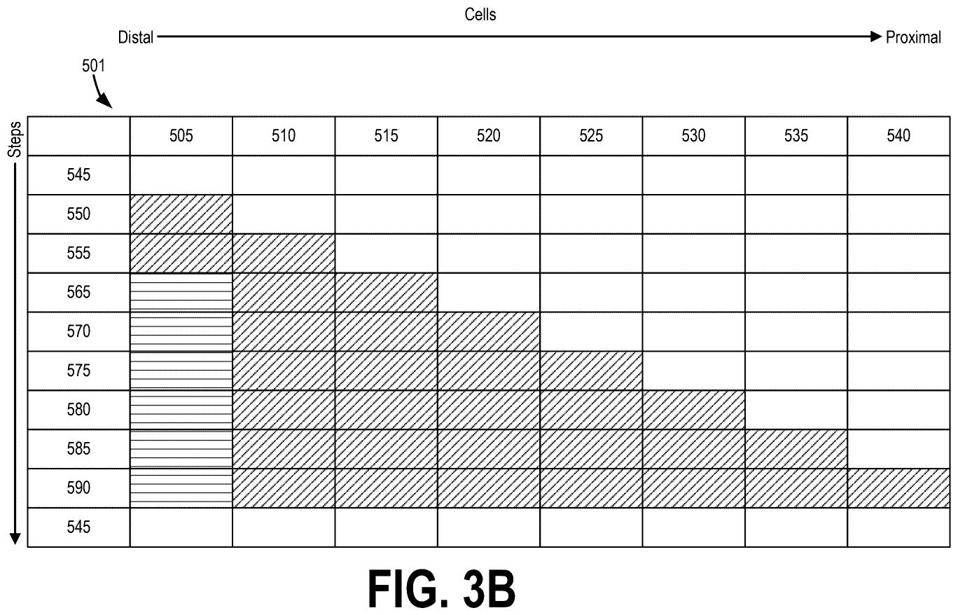

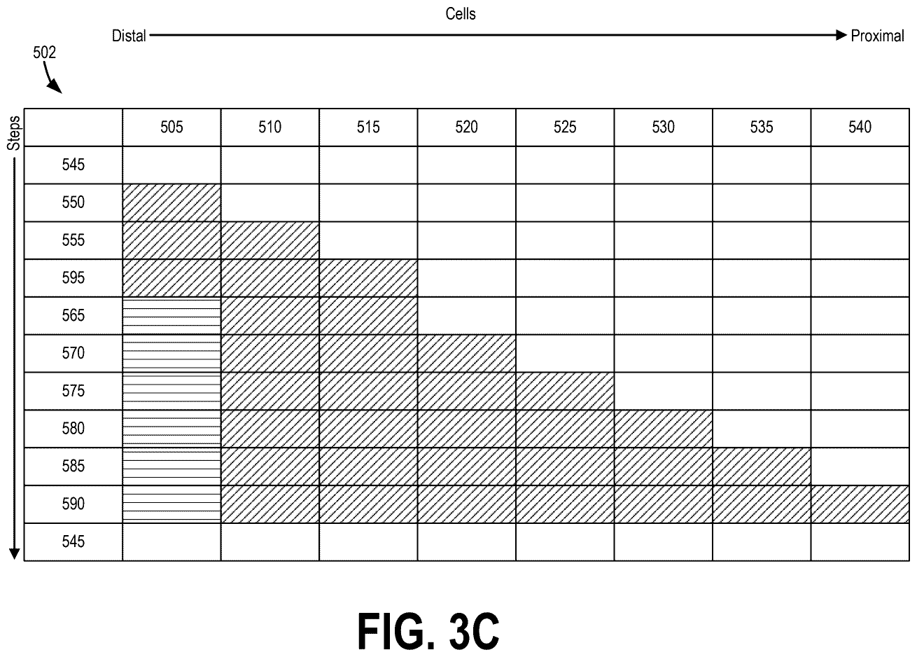

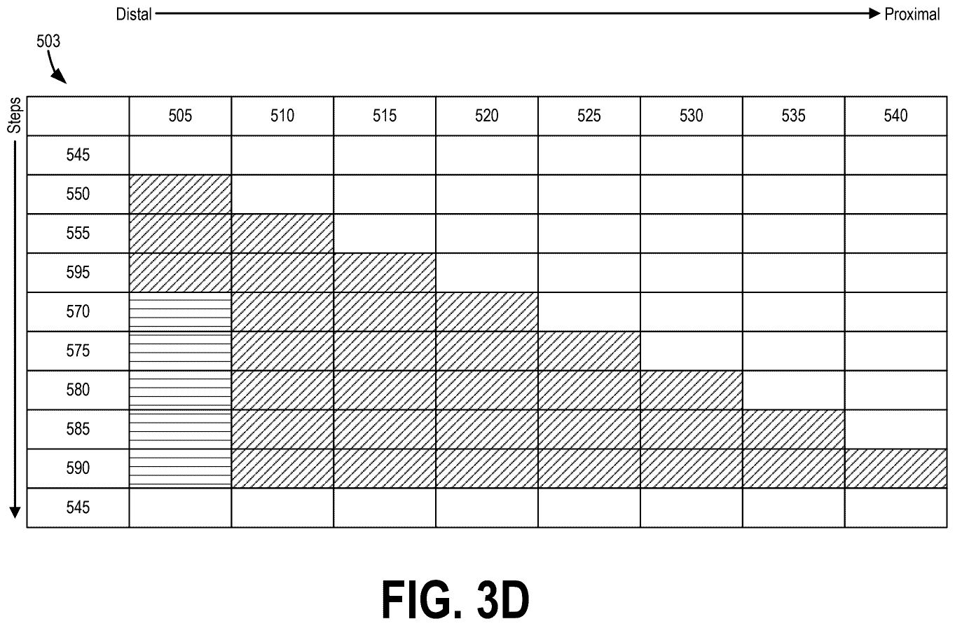

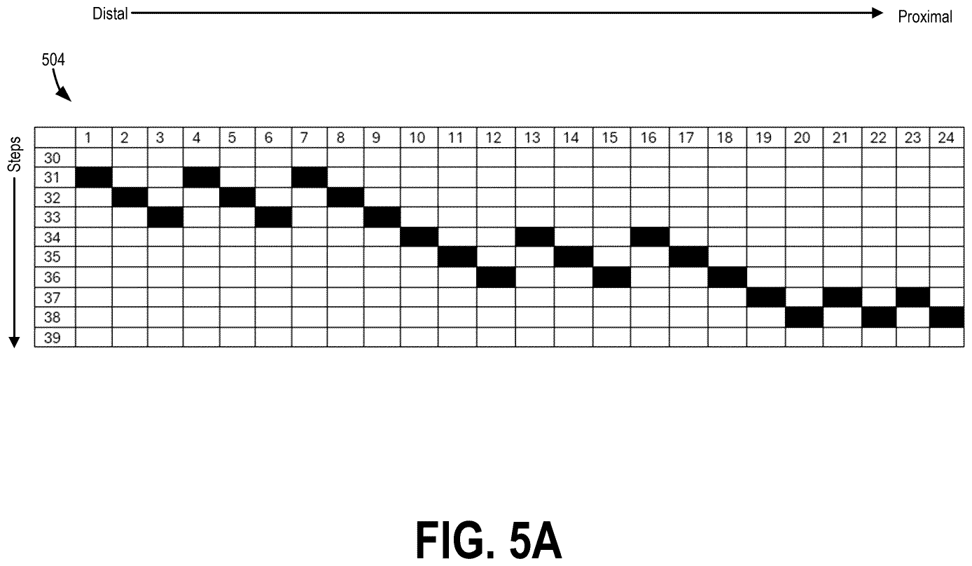

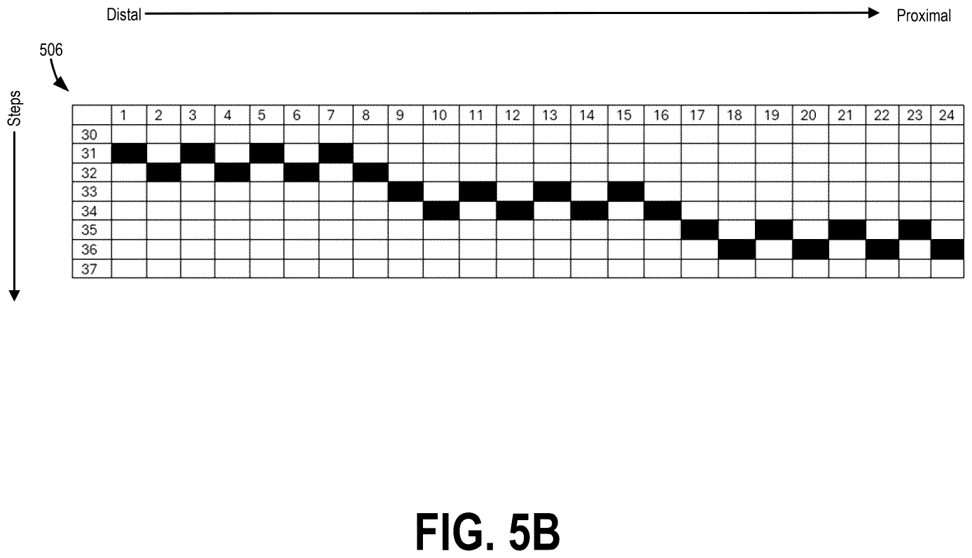

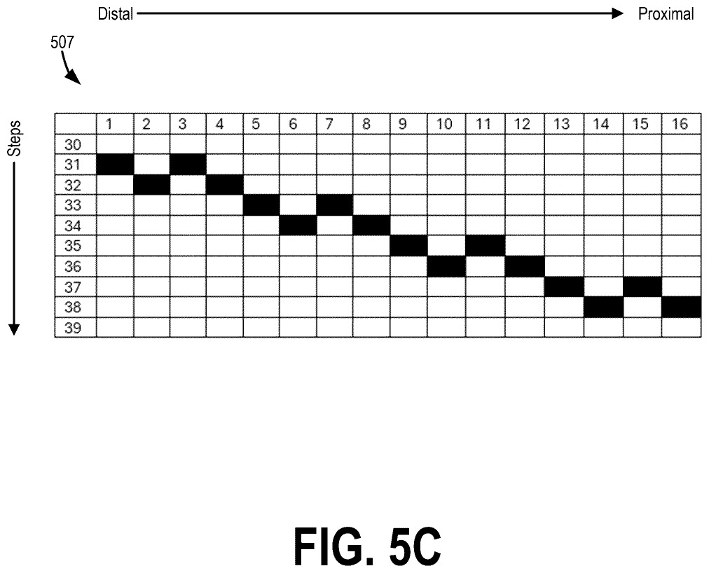

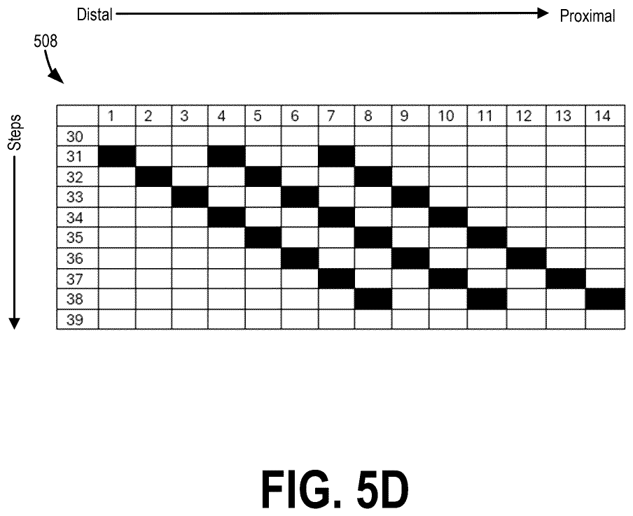

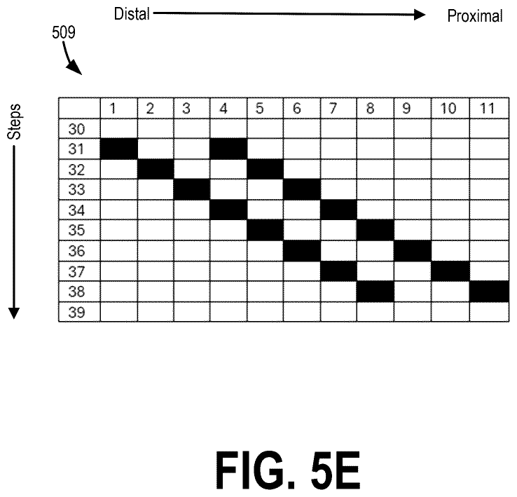

In some embodiments, each cell 120a-h may be individually connected to the controller 52. In some embodiments, groups of two or more cells 120a-h may be connected to the controller 52. The compression garment may include individual cells (or groups of two or more individual cells) 120a-h that may be selectively inflated by the controller 52 using a fluid. For example, the controller 52 may be configured to selectively pump fluid into one or more of the cells 120a-h to inflate the one or more cells according to a compression therapy protocol such as discussed herein with respect to FIGS. 3A-3D and 5A-5E. A manifold may allow the controller to selectively inflate one, two, or more cells at a time. For example a manifold may include individual fluid connection to each cell, or may include individual fluid connection to each group of cells.

In some embodiments, the controller 52 may control the pressure of each of independently inflatable cells 120a-h. For instance, the independently inflatable cells 120a-h may be inflated to individual pressure values or ranges, such as greater pressures for more distal cells and lower pressures for more proximal cells or vice versa. The independently inflatable cells 120a-h may be inflated to any pressure capable of use in compression therapy using a compression therapy device. For example, the independently inflatable cells 120a-h may be inflated to a pressure between and including about 5 mmHg (about 0.667 kPa) and about 150 mmHg (about 20.0 kPa). In some non-limiting examples, any one or more of independently inflatable cells 120a-h may be inflated to a pressure of about 5 mmHg (about 0.667 kPa), about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg (about 8.00 kPa), about 65 mmHg (about 8.67 kPa), about 70 mmHg (about 9.33 kPa), about 100 mmHg (about 13.3 kPa), about 120 mmHg (about 16.0 kPa), about 130 mmHg (about 17.3 kPa), about 150 mmHg (about 20.0 kPa), and values and ranges between any two of these values (including endpoints).

The independently inflatable cells 120a-h may be inflated (e.g., deflated) from any of the pressures listed above to another lower pressure capable of use in compression therapy using the compression therapy device. For example, the independently inflatable cells 120a-h may be inflatable (e.g., deflatable) to a pressure between and including about 0 mmHg (about 0 kPa) and about 150 mmHg (about 20.0 kPa). In some non-limiting examples, any one or more of independently inflatable cells 120 a-h may be inflated (e.g., deflated) to a pressure of about 5 mmHg (about 0.667 kPa), about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg (about 8.00 kPa), about 65 mmHg (about 8.67 kPa), about 70 mmHg (about 9.33 kPa), about 100 mmHg (about 13.3 kPa), about 120 mmHg (about 16.0 kPa), about 130 mmHg (about 17.3 kPa), about 140 mmHg (about 18.7 kPa), and values and ranges between any two of these values (including endpoints).

Although eight cells 120a-h are depicted in FIG. 1, embodiments are not so limited as the compression garment sleeve 105 may include more or fewer cells according to some embodiments. For example, the compression garment sleeve 105 may include 3 independently inflatable cells, 4 independently inflatable cells, 5 independently inflatable cells, 6 independently inflatable cells, 10 independently inflatable cells, 15 independently inflatable cells, 20 independently inflatable cells, 30 independently inflatable cells, 40 independently inflatable cells, and ranges between any two of these values (including endpoints). The independently inflatable cells 120a-h may be arranged in various configurations, including axially, longitudinally, circumferentially, in various patterns, and combinations thereof. Additionally, the independently inflatable cells 120a-h may be any shape or curvature. For example, one or more of the independently inflatable cells 120a-h may be arcuate in shape when viewed in a plan view and may define arcuate side walls as measured from side to side, or axially. In one or more embodiments, one or more of the independently inflatable cells 120a-h may be rectangular in shape and may define straight side walls as measured axially.

The compression garment sleeve 105 may be configured to provide compression therapy, for example, as part of a lymphedema therapy. The compression garment sleeve 105 depicted in FIG. 1 may be configured for compression therapy of an arm, with proximal cell 120a being configured to be arranged about the torso, upper arm, or shoulder, and distal cell 120h being configured to be arranged about the hand, wrist, or forearm of a patient. A physician or other medical professional may program and/or download to the controller 52 one or more compression therapy protocols specifying the sequence of inflation/deflation of one or more of the independently inflatable cells 120a-h as well as the individual pressure of each cell. For example, the controller 52 may be configured to implement the protocols illustrated in FIGS. 3A-3D, FIGS. 5A-5E, and/or variations thereof. In this manner, a patient may receive effective and individualized treatment for a medical condition, such as lymphedema or other edematous conditions.

The controller 52 is configured to apply pressure to one or more portions or regions of a body using the independently inflatable cells 120a-h through the control of fluid provided thereto, e.g., fluid flow, air flow, etc. For example, the compression garment sleeve 105 may include one or more ports through which fluid may be provided to the independently inflatable cells 120a-h via tubing 54. Each port included in the one or more ports can be associated with two or more specific cells included in the independently inflatable cells 120a-h. Alternatively, each port included in the one or more ports can be associated with a specific cell included in the independently inflatable cells 120a-h.

The controller, or control apparatus, 52 may be configured to, among other things, control the pressure applied to one or more portions or regions of the body using each of the independently inflatable cells 120a-h. For example, the controller 52 may control the pressure applied to the one or more portions or regions of the body by using each of the independently inflatable cells 120a-h independent from one another or at the same time. Further, for example, the independently inflatable cells 120a-h may be controlled in groups or combinations. In one or more embodiments, the controller 52 may be configured to control the independently inflatable cells 120a-h in a variety of different sequences (e.g., applying pressure in a predetermined manner) that may be, e.g., suitable for carrying out, or performing, lymphedema therapy. The controller 52 may be configured to provide compression therapy using more than one compression garment simultaneously or one-at-a-time.

Further, the controller 52 may control the pressure based on one or more pressures. Each of the one or more pressures may be measured by one or more pressure sensors associated with, or part of, the controller 52 and/or the compression garment sleeve 105. The one or more pressure sensors may be implemented for sensing pressure in a plurality of different manners at, e.g., a manifold for multiple cells, each pressure applying region, each cell, etc. For example, one or more pressure sensors may be located in a manifold that distributes fluid to one or more fluids cells of the pressure applying regions of various compression garments such as the independently inflatable cells 120a-h. Further, for example, one or more pressure sensors may be provided in the compression garment sleeve 105 proximate the independently inflatable cells 120a-h. Still further, pressure sensing apparatus may take the form of using pressure sensors within the garment as described in U.S. Pat. No. 9,027,408 entitled “Elastomeric Particle Having An Electrically Conducting Surface, A Pressure Sensor Comprising Said Particles, A Method For Producing Said Sensor And A Sensor System Comprising Said Sensors,” or a pump or control apparatus may be provided with pressure sensing functionality (e.g., measuring pressures of air in chambers as part of the pump apparatus) such as described in U.S. Pat. No. 7,947,003 entitled “Pressurized Medical Device,” all of which are incorporated by reference herein. One or more compression garments that may be modified with features (e.g., sensors) described herein may be similar to and include one or more features found in U.S. Pat. No. 6,860,862 entitled “Lymphedema Treatment System,” U.S. Pat. No. 6,966,884 entitled “Lymphedema Treatment System,” U.S. Pat. No. 6,179,796 entitled “Lymphedema treatment system,” and U.S. Pat. No. 6,645,165 entitled “Lymphedema treatment system,” which are herein incorporated by reference.

The controller 52 may further include a computing apparatus 51, which may include one or more processors employing one or more programs or routines carrying out one or more methods or processes. The computing apparatus 51 may implement such programs or routines with one or more types of memory. The computing apparatus 51 may be configured to control the system and/or one or more elements thereof (e.g., protocols, sequences, adjusting the delivery of fluid to one or more cells of the compression garment, displaying a graphical user interface used to configure compression therapy and/or view the status of ongoing compression therapy, identifying a compression garment using a communication interface that may be wireless, providing compression therapy using the one or more pressure applying regions, inflating or deflating a distal cell of the compression garment during a lymphedema compression therapy, etc.). In one or more embodiments, the computing apparatus 51 may be configured to control the compression system using wired and/or wireless technology.

The methods, logic, and configurations described in this disclosure, including those attributed to the systems or various constituent components, may be implemented, at least in part, in hardware, software, firmware, or any combination thereof. For example, various aspects of the techniques may be implemented within one or more processors, including one or more microprocessors, microcontrollers, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry.

Such hardware, software, and firmware may be implemented within the same device or within separate devices (e.g., within the system, outside of the system, or a combination of both) to support the various operations and functions described in this disclosure. In addition, any of the described components may be implemented together or separately as discrete but interoperable logic devices. Description of different features is intended to highlight different functional aspects and does not necessarily imply that such features must be realized by separate hardware or software components. Rather, functionality may be performed by separate hardware or software components, or integrated within common or separate hardware or software components.

When implemented in software, the functionality ascribed to the systems and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

Further, the controller 52 may include a pump 53 that may be controlled by the computing apparatus 51 to provide a fluid to and/or from one or more of the independently inflatable cells 120a-h. For example, the pump 53 may be connected to the plurality of inflatable cells, or inflatable chambers, corresponding to one or more of the independently inflatable cells 120a-h by tubing 54, so as to provide flow of fluid thereto or removal of fluid therefrom.

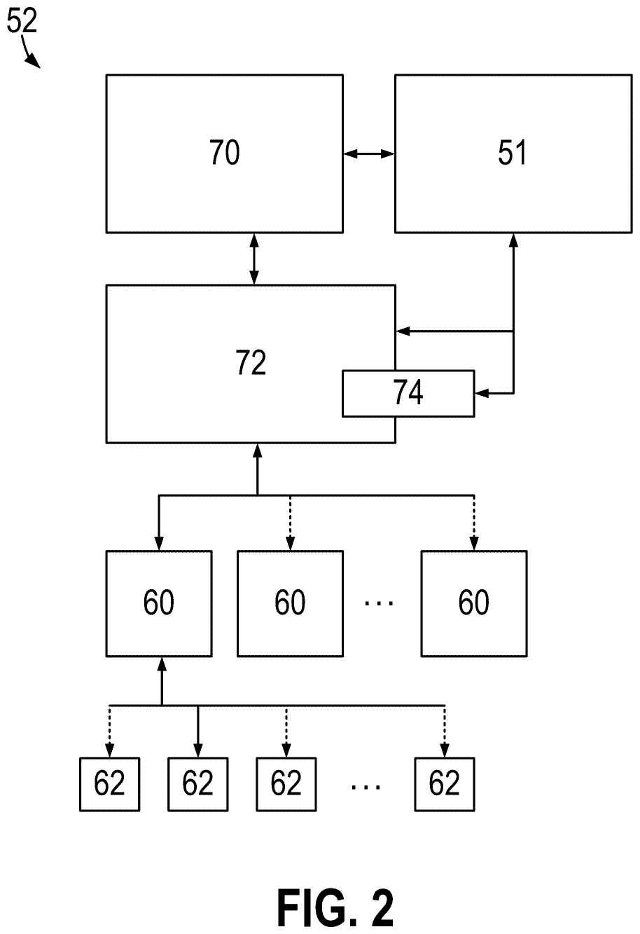

One illustrative embodiment of a controller 52 is depicted in FIG. 2. As shown, the controller 52 may include a plurality of ports 60. As depicted, the controller 52 includes, or defines, four ports 60. However, it is to be understood that some embodiments may include more than four ports 60 and some embodiments may include less than four ports 60. Each of the ports 60 may be operably couplable to a hose (or tubing), such as tubing 54, that are, in turn, operably coupled a compression garment. Each of the hoses, or tubing 54, may include multiple fluid lines, and each of the fluid lines may be operably coupled to a different inflatable cell of the compression garment, or to two or more inflatable cells of the compression garment.

Each of the ports 60 of the controller 52 may include a plurality of apertures 62, and each aperture of the plurality of apertures 62 may be operably couplable to two or more fluid lines of two or more hoses. Thus, each aperture of the plurality of apertures 62 may be operably coupled to a different group of cells of the compression garment when the hoses of the compression garment are operably coupled to two or more respective ports 60 of the controller 52. Alternatively, each aperture of the plurality of apertures 62 may be operably couplable to a separate fluid line of a hose. Thus, each aperture of the plurality of apertures 62 may be operably coupled to a different cell of the compression garment when the hose of the compression garment is operably coupled to a port 60 of the controller 52.

Further, although not depicted, the computing apparatus 51 may include data storage that may allow for access to processing programs or routines and one or more other types of data (e.g., sequences, protocols, target pressures, adjustable manifold pressures, compression garment identification information, graphical regions, graphical elements, graphical areas, saved compression therapy programs, default compression therapy programs, increased pressure values, decreased pressure values, baseline pressure values for one or more of the compression garment and one or more inflatable cells, metrics, variables, images, values, limits, text strings, macros, etc.) that may be employed to perform, or carry out, illustrative methods and/or processes (e.g., performing inflatable cell filling routines, measuring pressures, delivering fluid to inflatable cells, configuring compression therapy, saving compression therapy programs, identifying compression garments using a communication interface, displaying graphical user interfaces, allowing user interaction with graphical user interfaces, displaying graphical elements, displaying textual elements, displaying textual values, notifying operators/users of problems, etc.) for use in performing or configuring compression therapy.

Additionally, as shown in FIG. 1, in one or more embodiments, the controller 52 may be connected to one or more components of the compression therapy system 100 via one or more electrical lines and/or wirelessly. The one or more electrical lines are represented generally by dashed line(s) 56. The wireless connection(s) is represented generally by the wireless signal icons in FIG. 1. For example, the controller 52 may be connected to communicate with and to control the pressure applying regions (such as, e.g., the independently inflatable cells 120a-120h, electrically actuatable pressure applying regions of the garment configured to apply pressure to the body, etc.) with use of physical electrical connections and/or wirelessly. Further, for example, the controller 52 may further include a communication interface 59 to, e.g., communicate with the compression garment (e.g. sleeve 105), communicate with a user interface device 99 (e.g., a mobile telephone or other computing device,), etc. as represented generally by the wireless signal lines in FIG. 1. The communication interface 59 may be wireless interface that includes an antenna for sending and receiving signals using various wireless protocols such as, e.g., BLUETOOTH, WIFI, radiofrequency identification (RFID), etc.

In one or more embodiments, the controller 52 may be configured to identify a compression garment using the communication interface 59. For example, data about, or regarding, the compression garment may be transmitted to the controller 52 via the communication interface 59. Such data may include various information about the compression garment such as, for example, a serial number or unique identifier, a model number, a number of inflatable cells that the compression garment has, the size of the compression garment, the date of manufacturer, an expiration date, etc.

In response to receiving the data regarding the compression garment via the communication interface 59, the computing apparatus 51 of the controller 52 may configure compression therapy to be delivered by the compression garment based at least on the identity of the compression garment. For instance, different compression garments may utilize different compression therapy settings such as, e.g., different pressures, different durations, different pump, or fluid delivery, rates, sequences, protocols, etc., and the computing apparatus 51 may tailor, or customize, the compression for the identified compression garment.

Further, in one or more embodiments, the computing apparatus 51 may customize what is displayed to the user on a user interface device 99 based upon the identification of the compression garment. For example, if a leg compression garment is identified by the controller 52 via the communication interface 59, then the computing apparatus 51 may only, or may first, display leg compression therapy settings to a user. In this way, a user may not need to input, or select, the compression garment being used into the controller 52 prior to or during configuration of compression therapy using the controller 52.

In some embodiments, the controller 52 can receive a modification request from the user interface device 99. The modification request can include a request to change one or more stored pressures included in the controller (e.g., stored in the computing apparatus 51). The controller 52 can be configured to verify the request and prevent modification of stored pressures if the request is beyond one or more predetermined thresholds.

The data regarding the compression garment may be transferred to the controller 52 via the communication interface from the compression garment itself or another device. For example, the compression garment may include a wireless tag that when interrogated by the communication interface 59 will send data regarding the compression garment such as, e.g., identification information, to the communication interface 59. Further, for example, the user interface device 99 may wirelessly transmit data regarding the compression garment to the communication interface 59. In this way, a user may use an application, or app, running on their mobile telephone to instruct the controller 52 which compression garment the user will be using for compression therapy in conjunction with the controller 52. Further, the graphical regions, graphical areas, and graphical elements of the illustrative graphical user interfaces described herein may be transmitted via the communication interface 59 to a user interface device 99 such that, for example, a user may use their user interface device 99 to configure and/or interact with the controller 52 to, e.g., deliver and configure compression therapy. In some embodiments, some or all of the functionality of the user interface device 99 can be included in the controller 52.

The independently inflatable cells 120a-h of the compression garment (e.g., sleeve 105) may be described as being controllable since the independently inflatable cells 120a-h are under control of controller 52. Thus, the compression therapy system 100, using the controller 52, may be configured to provide, or deliver, compression therapy to an individual (e.g., a patient) wearing the compression garment (e.g., sleeve 105) such that lymph flows throughout the body in desired directions (e.g., from the leg(s) to the trunk, or torso, of the body). In other words, by controlling the independently inflatable cells 120a-h in a variety of different sequences (e.g., applying pressure in a predetermined manner), for example, lymph may flow generally from the leg(s) and lower trunk of the body towards the upper trunk of the body. The direction of lymph flow from the leg(s) to the trunk of the body may provide relief to an individual by moving excess lymph from the leg(s), and ultimately, moving such lymph towards and into one or more regions of the trunk such as, e.g., the right axillary nodes located proximate a right under arm region and the left axillary nodes located proximate a left under arm region.

The controller 52 may include a pump 70 that is operatively coupled to the computing apparatus 51 such that, for example, the computing apparatus 51 may control operation of the pump 70 to deliver fluid to one or more inflatable cells of a compression garment.

The controller 52 may further include a manifold 72 that is operatively coupled to the pump 70 to receive fluid (e.g., air) therefrom and to the computing apparatus 51 to receive control information (e.g., such that the computing apparatus 51 may control the manifold). Generally, the manifold 72 may be configurable or operable to select what inflatable cells of one or more compression garments connected thereto will receive fluid. To do so, the manifold 72 may include a plurality of valves that are controlled by the computing apparatus 51. The plurality of valves may select which of the plurality of ports 60 are to be operatively coupled to the pump 70 receive fluid therefrom and further which of the plurality of apertures 62 of the selected ports 60 are to be operatively coupled to the pump 70 receive fluid therefrom. In other words, using a plurality of valves of the manifold 72, one or more of the ports 60 may be selected, and then one or more apertures 62 of those selected ports 60 may be selected to receive fluid from the pump 70. In this way, the computing apparatus 51 may control which of the inflatable cells of the compression garment that are operably coupled to the controller 52 via the ports 60 and the plurality of apertures 62. A single aperture of the plurality of apertures 62 of one of the ports 60 is selected using valves of the manifold 72 as indicated by the solid line extending thereto while the other ports 60 and apertures 62 have dotted lines extending thereto (e.g., dotted lines indicating that valves of the manifold 72 have closed those fluid paths). Further, although not shown, it is to be understood that the manifold may be selectively vented (e.g., via one or more valves) to, e.g., release fluid from one or more inflatable cells that are operatively coupled to the manifold 72. In this way, the manifold 72 may be used to operatively fill or empty each of the plurality of inflatable cells via the ports 60 and apertures 62 thereof. In one or more embodiments, the manifold 72 may be used to operatively fill or empty two or more of the plurality of inflatable cells via a valve connected to two or more ports 60.

The controller 52 may further include a pressure sensor 74 located in the manifold 72 to measure pressure therein. When two or more apertures of the plurality of apertures 62 of a port 60 is selected such that the manifold 72 is operably coupled to multiple apertures, and thus, also operably coupled to multiple inflatable cells of a compression garment coupled thereto, the pressure sensor 74 may effectively measure the pressure of the multiple inflatable cells. When a single aperture of the plurality of apertures 62 of a port 60 is selected such that the manifold 72 is operably coupled to the single aperture, and thus, also operably coupled to a single inflatable cell of a compression garment coupled thereto, the pressure sensor 74 may effectively measure the pressure of the inflatable cell. Additionally, the pressure sensor 74 may be configured to measure a pressure value while the pump 70 is running or while the pump 70 is stopped. In this way, a pressure value may be measured from the manifold 72 during delivery of fluid from the pump 70 to one, two, or more of the independently inflatable cells 120a-120h, and such measured pressure value may be used to determine when to cease delivery of fluid from the pump 70 to the inflatable cell(s) (e.g., when to turn the pump 70 “off” to achieve a desired pressure within the inflatable cell(s)). Then, a pressure value may be measured from the manifold 72 after delivery of fluid from the pump 70 to the inflatable cell(s) when the pump 70 is not delivering fluid to the inflatable cell(s) to measure the “actual” pressure of the inflatable cell(s) (e.g., unaffected by the pump 70 running or delivering fluid). Although a single pressure sensor 74 is described herein with reference to FIG. 2, it is to be understood that the illustrative systems, apparatus, and methods describe herein may use, or utilize, any number of pressure sensors located in various positions to measure a plurality of redundant or different pressure values during fluid delivery or when fluid delivery has ceased.

FIGS. 3A-3D depict illustrative compression therapy protocols according to some embodiments. One or more of the compression therapy protocols depicted in FIGS. 3A-3D may be used in any sequence and/or combination. In addition, one or more of the compression therapy protocols depicted in FIGS. 3A-3D may be used in sequence and/or combination with any other compression therapy protocol known to those having ordinary skill in the art.

Each of the protocols depicted in FIGS. 3A-3D provide therapy to limbs with improved comfort for the user over previous approaches. More specifically, the protocols provide lymphedema treatment for a limb such as a leg or an arm, while minimizing discomfort at the distal end (e.g., foot, ankle, etc.) of the limb during treatment. Moreover, it may be described that the illustrative systems, devices, and methods provide suitable lymphedema treatment that can be completed without applying a sustained high pressure to the distal cell (e.g., cell 120h in FIG. 1) of a limb therapy device (e.g., sleeve 105). Thus, each of the protocols in FIGS. 3A-3D provide therapy to a limb while reducing at least some of the pressure provided to distal portions of a limb during the treatment. The reduced pressure applied in the protocols in FIGS. 3A-3D provide enhanced comfort to the user without impacting the efficacy of the treatment afforded by the compression garment (e.g., sleeve 105).

Each of the protocols may be provided as instructions in the controller 52 (e.g., as computer readable instructions on the computing apparatus 51). The controller 52 can cause one or more independently inflatable cells 120a-h of the compression garment (e.g., sleeve 105) to inflate and/or deflate to a target pressure specified by the protocol. The target pressure may be the desired pressure for each independently inflatable cell. Additionally, it is to be understood that the target pressure may include a tolerance of, for example, about 5%. In other embodiments, the tolerance may be greater than or equal to about 0.5%, greater than or equal to about 1%, greater than or equal to about 2%, greater than or equal to about 3%, greater than or equal to about 6.5%, etc. and/or less than or equal to about 10%, less than or equal to about 7.5%, less than or equal to about 6%, less than or equal to about 4%, less than or equal to about 3.5%, less than or equal to about 2.5%, etc. Thus, in this example, a measured pressure within a selected percentage of the target pressure would be determined as “meeting” or achieving the target pressure. Furthermore, a measured pressure that is less than the selected percentage of the target pressure would be determined as being less than the target pressure, and conversely, a measured pressure that is greater than the selected percentage of the target pressure would be determined as being greater than the target pressure.

FIG. 3A depicts an illustrative compression therapy protocol 500 or pattern for a compression garment (such as the compression garment depicted in FIG. 1) having eight cells 505-540 illustrated along the x-axis. In some embodiments, cell 505 may be the distal cell (for example, closest to the foot or arm), cell 540 may be the proximal cell (for example, closest to the torso), and cells 510-535 may be intermediate cells. One having ordinary skill in the art would understood that the description that follows, although specifically referencing an eight-cell compression garment as depicted in FIG. 1, may similarly apply to compression garments having more or fewer cells and to compression garments used on body portions other than the extremities.

Each step 545, 550, 555, 560, 565, 570, 575, 580, 585, 590 may be active for a particular duration specified by the compression therapy protocol 500. In some embodiments, each step 545, 550, 555, 560, 565, 570, 575, 580, 585, 590 may last for the same duration. In some embodiments, one or more steps 545, 550, 555, 560, 565, 570, 575, 580, 585, 590 may last for different durations. For example, each step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 545, each of the cells 505-540 are deflated to 0 mmHg. The therapy protocol 500 may begin at step 545. At step 545, a patient may don the compression garment. For example, the patient may don a compression garment proximate at least a portion of a foot (e.g., the left foot), at least a portion of a leg (e.g., the left leg) and at least a portion of corresponding side of the torso of the patient (e.g., the left side of the torso).

At step 550, the distal cell 505 is inflated to a first pressure. The first pressure can vary based on the desired intensity (e.g., prescribed intensity) of the compression therapy protocol 500. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso.

At step 555, the distal cell 505 and the intermediate, cell 510 are inflated to the first pressure. If the step 555 is executed after step 550, the first pressure at the distal cell 505 is maintained, and the cell 510 is inflated to the first pressure. The cell 510 may be referred to as a proximal cell or an intermediate cell.

At step 560, the distal cell 505 is inflated to a second pressure and the proximal cell 510 is inflated to the first pressure. If the step 560 is executed after step 555, the first pressure at the cell 510 is maintained, and the distal cell 505 is deflated to a second pressure. The second pressure is less than the first pressure and greater than zero mmHg. In some embodiments, the second pressure can be about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). It may be described that, at step 560, the compression therapy protocol 500 using cell 510 can prevent lymphatic fluid from regressing back towards the distal region of the limb and the distal cell 505, while providing greater comfort to the user by relaxing the pressure applied to the distal cell 505.

At step 565, the distal cell 505 remains inflated to the second pressure and the cells 510-515 remain or are inflated to the first pressure. If the step 565 is executed after step 560, the second pressure at the distal cell 505 is maintained, the first pressure at the cell 510 is maintained, and the cell 515 is inflated to the first pressure. The cell 515 may be referred to as a proximal cell or an intermediate cell.

At step 570, the distal cell 505 remains inflated to the second pressure and the cells 510-520 remain or are inflated to the first pressure. If the step 570 is executed after step 565, the second pressure at the distal cell 505 is maintained, the first pressure at the cells 510-515 is maintained, and the cell 520 is inflated to the first pressure. The cell 520 may be referred to as a proximal cell or an intermediate cell.

At step 575, the distal cell 505 remains inflated to the second pressure and the cells 510-525 remain or are inflated to the first pressure. If the step 575 is executed after step 570, the second pressure at the distal cell 505 is maintained, the first pressure at the cells 510-520 is maintained, and the cell 525 is inflated to the first pressure. The cell 525 may be referred to as a proximal cell or an intermediate cell.

At step 580, the distal cell 505 remains inflated to the second pressure and the cells 510-530 remain or are inflated to the first pressure. If the step 580 is executed after step 575, the second pressure at the distal cell 505 is maintained, the first pressure at the cells 510-525 is maintained, and the cell 530 is inflated to the first pressure. The cell 530 may be referred to as a proximal cell or an intermediate cell.

At step 585, the distal cell 505 remains inflated to the second pressure and the cells 510-535 remain or are inflated to the first pressure. If the step 585 is executed after step 580, the second pressure at the distal cell 505 is maintained, the first pressure at the cells 510-530 is maintained, and the cell 535 is inflated to the first pressure. The cell 535 may be referred to as a proximal cell or an intermediate cell.

At step 590, the distal cell 505 remains inflated to the second pressure and the cells 510-540 remain or are inflated to the first pressure. If the step 590 is executed after step 585, the second pressure at the distal cell 505 is maintained, the first pressure at the cells 510-535 is maintained, and the cell 540 is inflated to the first pressure. The cell 540 may be referred to as a proximal cell or an intermediate cell.

The steps 545, 550, 555, 560, 565, 570, 575, 580, 585, 590 can occur in the order shown in FIG. 3A, with earlier steps located at the top of the compression therapy protocol 500 (e.g., step 545), and later steps located at the bottom of the compression therapy protocol 500 (e.g., step 590). The steps can occur in the following order: step 545, followed by step 550, followed by step 555, followed by step 560, followed by step 565, followed by step 570, followed by step 575, followed by step 580, followed by step 585, followed by step 590. After step 590, the protocol may proceed to step 545 and deflate all of the cells 505-540 to zero mmHg.

In some embodiments, each step can occur immediately after the previous step. For example, step 550 may occur immediately after step 545. In other embodiments, at least one step can be held for a period of time before the next step has begun. For example, step 545 may be held for some period of time before step 550 occurs. In some embodiments, the period of time between may vary between pairs of steps. For example, step 545 may be held for a first period of time before step 550 occurs, and step 550 may be held for a second period of time before step 555 occurs. The time between steps may be programmed into the controller 52 or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 545, 550, 555, 560, 565, 570, 575, 580, 585, 590 may be active for any duration capable of operating according to some embodiments described herein. With respect to FIG. 3A, a cycle may be defined as a sequence of step 545, followed by step 550, followed by step 555, followed by step 560, followed by step 565, followed by step 570, followed by step 575, followed by step 580, followed by step 585, followed by step 590. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 505-540 may be deflated at step 545 for a duration after the completion of the compression therapy protocol 500.

Referring now to FIG. 3B, an illustrative compression therapy protocol 501 or pattern for a compression garment (such as the compression garment depicted in FIG. 1) having eight cells 505-540 is shown. In some embodiments, cell 505 may be the distal cell (for example, closest to the foot or arm), cell 540 may be the proximal cell (for example, closest to the torso), and cells 510-535 may be intermediate cells. One having ordinary skill in the art would understood that the description that follows, although specifically referencing an eight-cell compression garment as depicted in FIG. 1, may similarly apply to compression garments having more or fewer cells and to compression garments used on body portions other than the extremities.

Each step 545, 550, 555, 565, 570, 575, 580, 585, 590 may be active for a particular duration specified by the compression therapy protocol 501. In some embodiments, each step 545, 550, 555, 565, 570, 575, 580, 585, 590 may last for the same duration. In some embodiments, one or more steps 545, 550, 555, 565, 570, 575, 580, 585, 590 may last for different durations. For example, the step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 545, each of the cells 505-540 are deflated to 0 mmHg. The therapy protocol 500 may begin at step 545. At step 545, a patient may don the compression garment. For example, the patient may don a compression garment proximate at least a portion of a foot (e.g., the left foot), at least a portion of a leg (e.g., the left leg) and at least a portion of corresponding side of the torso of the patient (e.g., the left side of the torso).

At step 550, the distal cell 505 is inflated to a first pressure. The first pressure can vary based on the desired intensity (e.g., prescribed intensity) of the protocol 500. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso.

At step 555, the distal cell 505 and the cell 510 are inflated to the first pressure. If the step 555 is executed after step 550, the first pressure at the distal cell 505 is maintained, and the cell 510 is inflated to the first pressure. The cell 510 may be referred to as a proximal cell or an intermediate cell.

At step 565, the distal cell 505 is inflated to a second pressure and the cells 510-515 are inflated to the first pressure. If the step 565 is executed after step 555, the distal cell 505 is deflated to the second pressure, the first pressure at the cell 510 is maintained, and the cell 515 is inflated to the first pressure. The cell 515 may be referred to as a proximal cell or an intermediate cell. The second pressure is less than the first pressure and greater than zero mmHg. In some embodiments, the second pressure can be about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). It may be described that, at step 565, the protocol 501 using the cell 510 can prevent lymphatic fluid from regressing back towards the distal region of the limb and the distal cell 505, while providing greater comfort to the user by relaxing the pressure applied to the distal cell 505 region of the limb (e.g., the foot).

At step 570, the distal cell 505 remains inflated to the second pressure and the cells 510-520 remain or are inflated to the first pressure. If the step 570 is executed after step 565, the second pressure at the distal cell 505 is maintained, the first pressure at the cells 510-515 is maintained, and the cell 520 is inflated to the first pressure. The cell 520 may be referred to as a proximal cell or an intermediate cell.

At step 575, the distal cell 505 remains inflated to the second pressure and the cells 510-525 remain or are inflated to the first pressure. If the step 575 is executed after step 570, the second pressure at the distal cell 505 is maintained, the first pressure at the cells 510-520 is maintained, and the cell 525 is inflated to the first pressure. The cell 525 may be referred to as a proximal cell or an intermediate cell.

At step 580, the distal cell 505 is inflated to the second pressure and the cells 510-530 remain or are inflated to the first pressure. If the step 580 is executed after step 575, the second pressure at the distal cell 505 is maintained, the first pressure at the cells 510-525 is maintained, and the cell 530 is inflated to the first pressure. The cell 530 may be referred to as a proximal cell or an intermediate cell.

At step 585, the distal cell 505 is inflated to the second pressure and the cells 510-535 remain or are inflated to the first pressure. If the step 585 is executed after step 580, the second pressure at the distal cell 505 is maintained, the first pressure at the cells 510-530 is maintained, and the cell 535 is inflated to the first pressure. The cell 535 may be referred to as a proximal cell or an intermediate cell.

At step 590, the distal cell 505 is inflated to the second pressure and the cells 510-540 remain or are inflated to the first pressure. If the step 590 is executed after step 585, the second pressure at the distal cell 505 is maintained, the first pressure at the cells 510-535 is maintained, and the cell 540 is inflated to the first pressure. The cell 540 may be referred to as a proximal cell or an intermediate cell.

The steps 545, 550, 555, 565, 570, 575, 580, 585, 590 can occur in the order shown in FIG. 3B, with earlier steps located at the top of the compression therapy protocol 501 (e.g., step 545), and later steps located at the bottom of the protocol 501 (e.g., step 590). The steps can occur in the following order: step 545, followed by step 550, followed by step 555, followed by step 565, followed by step 570, followed by step 575, followed by step 580, followed by step 585, followed by step 590. After step 590, the protocol may proceed to step 545 and deflate all of the cells 505-540 to zero mmHg.

In some embodiments, each step can occur immediately after the previous step. For example, step 550 may occur immediately after step 545. In other embodiments, at least one step can be held for a period of time before the next step has begun. For example, step 545 may be held for some period of time before step 550 occurs. In some embodiments, the period of time between may vary between pairs of steps. For example, step 545 may be held for a first period of time before step 550 occurs, and step 550 may be held for a second period of time before step 555 occurs. The time between steps may be programmed into the controller 52 or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 545, 550, 555, 565, 570, 575, 580, 585, 590 may be active for any duration capable of operating according to some embodiments described herein. With respect to FIG. 3B, a cycle may be defined as a sequence of step 545, followed by step 550, followed by step 555, followed by step 565, followed by step 570, followed by step 575, followed by step 580, followed by step 585, followed by step 590. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 505-540 may be deflated at step 545 for a duration after the completion of the compression therapy protocol 501.

Referring now to FIG. 3C, an illustrative compression therapy protocol 502 or pattern for a compression garment (such as the compression garment depicted in FIG. 1) having eight cells 505-540 is shown. In some embodiments, cell 505 may be the distal cell (for example, closest to the foot or arm), cell 540 may be the proximal cell (for example, closest to the torso), and cells 510-535 may be intermediate cells. One having ordinary skill in the art would understood that the description that follows, although specifically referencing an eight-cell compression garment as depicted in FIG. 1, may similarly apply to compression garments having more or fewer cells and to compression garments used on body portions other than the extremities.

Each step 545, 550, 555, 595, 565, 570, 575, 580, 585, 590 may be active for a particular duration specified by the compression therapy protocol 502. In some embodiments, each step 545, 550, 555, 595, 565, 570, 575, 580, 585, 590 may last for the same duration. In some embodiments, one or more steps 545, 550, 555, 595, 565, 570, 575, 580, 585, 590 may last for different durations. For example, the step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 545, each of the cells 505-540 are deflated to 0 mmHg. The therapy protocol 500 may begin at step 545. At step 545, a patient may don the compression garment. For example, the patient may don a compression garment proximate at least a portion of a foot (e.g., the left foot), at least a portion of a leg (e.g., the left leg) and at least a portion of corresponding side of the torso of the patient (e.g., the left side of the torso).

At step 550, the distal cell 505 is inflated to a first pressure. The first pressure can vary based on the desired intensity (e.g., prescribed intensity) of the protocol 502. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso.

At step 555, the distal cell 505 and the cell 510 are inflated to the first pressure. If the step 555 is executed after step 550, the first pressure at the distal cell 505 is maintained, and the cell 510 is inflated to the first pressure. The cell 510 may be referred to as a proximal cell or an intermediate cell.

At step 595, the distal cell 505 and the cells 510-515 are inflated to the first pressure. If the step 595 is executed after step 555, the first pressure at the distal cell and the cell 510 is maintained, and the cell 515 is inflated to the first pressure. The cell 515 may be referred to as a proximal cell or an intermediate cell.

At step 565, the distal cell 505 is inflated to a second pressure and the cells 510-515 are inflated to the first pressure. If the step 565 is executed after step 595, the distal cell 505 is deflated to the second pressure, and the first pressure at the cells 510-515 is maintained. The second pressure is less than the first pressure and greater than zero mmHg. In some embodiments, the second pressure can be about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). At step 565, the protocol 502 can prevent lymphatic fluid from regressing back towards the distal region of the limb and the distal cell 505, while providing greater comfort to the user by relaxing the pressure applied to the distal cell 505 region of the limb (e.g., the foot).

At step 570, the distal cell 505 remains inflated to the second pressure and the cells 510-520 remains or are inflated to the first pressure. If the step 570 is executed after step 565, the second pressure at the distal cell 505 is maintained, the first pressure at the cells 510-515 is maintained, and the cell 520 is inflated to the first pressure. The cell 520 may be referred to as a proximal cell or an intermediate cell.

At step 575, the distal cell 505 remains inflated to the second pressure and the cells 510-525 remains or are inflated to the first pressure. If the step 575 is executed after step 570, the second pressure at the distal cell 505 is maintained, the first pressure at the cells 510-520 is maintained, and the cell 525 is inflated to the first pressure. The cell 525 may be referred to as a proximal cell or an intermediate cell.

At step 580, the distal cell 505 remains inflated to the second pressure and the cells 510-530 remains or are inflated to the first pressure. If the step 580 is executed after step 575, the second pressure at the distal cell 505 is maintained, the first pressure at the cells 510-525 is maintained, and the cell 530 is inflated to the first pressure. The cell 530 may be referred to as a proximal cell or an intermediate cell.

At step 585, the distal cell 505 remains inflated to the second pressure and the cells 510-535 remains or are inflated to the first pressure. If the step 585 is executed after step 580, the second pressure at the distal cell 505 is maintained, the first pressure at the cells 510-530 is maintained, and the cell 535 is inflated to the first pressure. The cell 535 may be referred to as a proximal cell or an intermediate cell.

At step 590, the distal cell 505 remains inflated to the second pressure and the cells 510-540 remains or are inflated to the first pressure. If the step 590 is executed after step 585, the second pressure at the distal cell 505 is maintained, the first pressure at the cells 510-535 is maintained, and the cell 540 is inflated to the first pressure. The cell 540 may be referred to as a proximal cell or an intermediate cell.

The steps 545, 550, 555, 595, 565, 570, 575, 580, 585, 590 can occur in the order shown in FIG. 3C, with earlier steps located at the top of the protocol 502 (e.g., step 545), and later steps located at the bottom of the protocol 502 (e.g., step 590). The steps can occur in the following order: step 545, followed by step 550, followed by step 555, followed by step 595, followed by step 565, followed by step 570, followed by step 575, followed by step 580, followed by step 585, followed by step 590. After step 590, the protocol may proceed to step 545 and deflate all of the cells 505-540 to zero mmHg.

In some embodiments, each step can occur immediately after the previous step. For example, step 550 may occur immediately after step 545. In other embodiments, at least one step can be held for a period of time before the next step has begun. For example, step 545 may be held for some period of time before step 550 occurs. In some embodiments, the period of time between may vary between pairs of steps. For example, step 545 may be held for a first period of time before step 550 occurs, and step 550 may be held for a second period of time before step 555 occurs. The time between steps may be programmed into the controller 52 or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 545, 550, 555, 595, 565, 570, 575, 580, 585, 590 may be active for any duration capable of operating according to some embodiments described herein. With respect to FIG. 3C, a cycle may be defined as a sequence of step 545, followed by step 550, followed by step 555, followed by step 595, followed by step 565, followed by step 570, followed by step 575, followed by step 580, followed by step 585, followed by step 590. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 505-540 may be deflated at step 545 for a duration after the completion of the compression therapy protocol 502.

Referring now to FIG. 3D, an illustrative compression therapy protocol 503 or pattern for a compression garment (such as the compression garment depicted in FIG. 1) having eight cells 505-540 is shown. In some embodiments, cell 505 may be the distal cell (for example, closest to the foot or arm), cell 540 may be the proximal cell (for example, closest to the torso), and cells 510-535 may be intermediate cells. One having ordinary skill in the art would understood that the description that follows, although specifically referencing an eight-cell compression garment as depicted in FIG. 1, may similarly apply to compression garments having more or fewer cells and to compression garments used on body portions other than the extremities.

Each step 545, 550, 555, 595, 570, 575, 580, 585, 590 may be active for a particular duration specified by the compression therapy protocol 503. In some embodiments, each step 545, 550, 555, 595, 570, 575, 580, 585, 590 may last for the same duration. In some embodiments, one or more steps 545, 550, 555, 595, 570, 575, 580, 585, 590 may last for different durations. For example, the step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 545, each of the cells 505-540 are deflated to 0 mmHg. The therapy protocol 500 may begin at step 545. At step 545, a patient may don the compression garment. For example, the patient may don a compression garment proximate at least a portion of a foot (e.g., the left foot), at least a portion of a leg (e.g., the left leg) and at least a portion of corresponding side of the torso of the patient (e.g., the left side of the torso).

At step 550, the distal cell 505 is inflated to a first pressure. The first pressure can vary based on the desired intensity (e.g., prescribed intensity) of the protocol 503. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso.

At step 555, the distal cell 505 and the cell 510 remain or are inflated to the first pressure. If the step 555 is executed after step 550, the first pressure at the distal cell 505 is maintained, and the cell 510 is inflated to the first pressure. The cell 510 may be referred to as a proximal cell or an intermediate cell.

At step 595, the distal cell 505 and the cells 510-515 remain or are inflated to the first pressure. If the step 595 is executed after step 555, the first pressure at the distal cell and the cell 510 is maintained, and the cell 515 is inflated to the first pressure. The cell 515 may be referred to as a proximal cell or an intermediate cell.

At step 570, the distal cell 505 is inflated to a second pressure and the cells 510-520 are inflated to the first pressure. If the step 570 is executed after step 595, the distal cell 505 is deflated to the second pressure, the first pressure at the cells 510-515 is maintained, and the cell 520 is inflated to the first pressure. The cell 520 may be referred to as a proximal cell or an intermediate cell. The second pressure is less than the first pressure and greater than zero mmHg. In some embodiments, the second pressure can be about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). At step 570, the protocol 503 can prevent lymphatic fluid from regressing back towards the distal region of the limb and the distal cell 505, while providing greater comfort to the user by relaxing the pressure applied to the distal cell 505 region of the limb (e.g., the foot).

At step 575, the distal cell 505 remains inflated to the second pressure and the cells 510-525 remain or are inflated to the first pressure. If the step 575 is executed after step 570, the second pressure at the distal cell 505 is maintained, the first pressure at the cells 510-520 is maintained, and the cell 525 is inflated to the first pressure. The cell 525 may be referred to as a proximal cell or an intermediate cell.

At step 580, the distal cell 505 remains inflated to the second pressure and the cells 510-530 remain or are inflated to the first pressure. If the step 580 is executed after step 575, the second pressure at the distal cell 505 is maintained, the first pressure at the cells 510-525 is maintained, and the cell 530 is inflated to the first pressure. The cell 530 may be referred to as a proximal cell or an intermediate cell.

At step 585, the distal cell 505 remains inflated to the second pressure and the cells 510-535 remain or are inflated to the first pressure. If the step 585 is executed after step 580, the second pressure at the distal cell 505 is maintained, the first pressure at the cells 510-530 is maintained, and the cell 535 is inflated to the first pressure. The cell 535 may be referred to as a proximal cell or an intermediate cell.

At step 590, the distal cell 505 remains inflated to the second pressure and the cells 510-540 remain or are inflated to the first pressure. If the step 590 is executed after step 585, the second pressure at the distal cell 505 is maintained, the first pressure at the cells 510-535 is maintained, and the cell 540 is inflated to the first pressure. The cell 540 may be referred to as a proximal cell or an intermediate cell.

The steps 545, 550, 555, 595, 570, 575, 580, 585, 590 can occur in the order shown in FIG. 3D, with earlier steps located at the top of the protocol 503 (e.g., step 545), and later steps located at the bottom of the protocol 503 (e.g., step 590). The steps can occur in the following order: step 545, followed by step 550, followed by step 555, followed by step 595, followed by step 570, followed by step 575, followed by step 580, followed by step 585, followed by step 590. After step 590, the protocol may proceed to step 545 and deflate all of the cells 505-540 to zero mmHg.

In some embodiments, each step can occur immediately after the previous step. For example, step 550 may occur immediately after step 545. In other embodiments, at least one step can be held for a period of time before the next step has begun. For example, step 545 may be held for some period of time before step 550 occurs. In some embodiments, the period of time between may vary between pairs of steps. For example, step 545 may be held for a first period of time before step 550 occurs, and step 550 may be held for a second period of time before step 555 occurs. The time between steps may be programmed into the controller 52 or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 545, 550, 555, 595, 570, 575, 580, 585, 590 may be active for any duration capable of operating according to some embodiments described herein. With respect to FIG. 3D, a cycle may be defined as a sequence of step 545, followed by step 550, followed by step 555, followed by step 595, followed by step 570, followed by step 575, followed by step 580, followed by step 585, followed by step 590. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 505-540 may be deflated at step 545 for a duration after the completion of the compression therapy protocol 503.

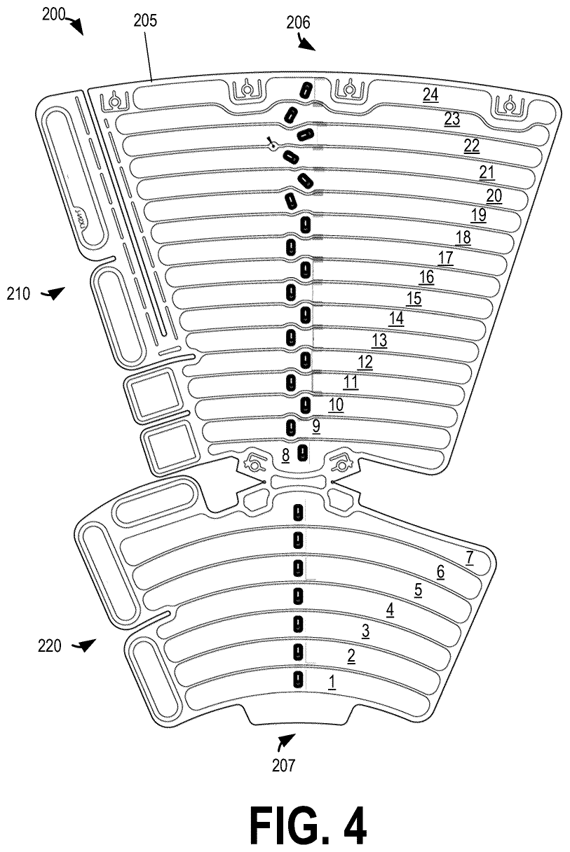

Referring now to FIG. 4, another illustrative compression therapy system 200 is shown. The compression therapy system 200 may include a compression garment 205 (e.g., a sleeve) configured to be pulled over and/or wrapped around a limb (e.g., an arm, a leg, etc.). The compression garment 205 may be further configured to encase the limb. The compression garment 205 can include a proximal opening 206 and a distal opening 207. The compression garment 205 may include a proximal portion 210 and a distal portion 220. In one or more embodiment, the proximal portion 210 may be configured to be wrapped around a calf and the distal portion 220 may be configured to be wrapped around a foot or ankle. The compression garment 205 may include a plurality of independently inflatable cells 1-24.

The patient may attach tubing (such as tubing 54 discussed herein) from the garment port(s) to a controller (such as controller 52 discussed herein). In one non-limiting example, the plurality of independently inflatable cells 1-24 may be arranged in the compression garment in an ordered sequence. Each of the independently inflatable cells 1-24 can be arranged adjacent to each other in the ordered sequence. In some embodiments, the independently inflatable cells 1-24 can be immediately adjacent to each other, where there is minimal separation between each individually inflatable cell. In some embodiments, the independently inflatable cells 1-24 can be adjacent to each other and separated by a seam defining each cell (as shown in FIG. 4). The independently inflatable cells 1-24 may be arranged from a proximal cell 24 to a distal cell 1, with a plurality of intermediate cells 2-23 disposed therebetween. The independently inflatable cells 1-24 can be arranged sequentially and adjacent to each other from the proximal opening 206 to the distal opening 207.

In one or more embodiments, the garment is a lower limb garment and the proximal portion 210 is configured to be wrapped around a calf and the distal portion 220 is configured to be wrapped around a foot or ankle. In alternative embodiments, the garment is an upper limb garment and the proximal cell 24 may be disposed at a proximal location of a patient, for example at a shoulder or the upper arm, and the distal cell 1 may be disposed at a distal location of a patient, for example at a wrist or a hand. In further alternative embodiments, the garment may be a lower limb garment and the proximal cell 24 may be disposed at a proximal location of a patient, for example at a hip, a waist, a groin, an upper thigh, or an abdomen, and the distal cell 1 may be disposed at a distal location of a patient, for example at a calf, an ankle, or a foot.

In some embodiments, each cell 1-24 may be individually connected to the controller. In some embodiments, a group of cells may be connected together to the controller. The compression garment may include individual cells 1-24, or a group of those cells, which may be selectively inflated by the controller using a fluid. For example, the controller may be configured to selectively pump fluid into the cells 1-24 to inflate the cells according to a compression therapy protocol (see FIGS. 3A-3D described above and FIGS. 5A-5E described below).

In some embodiments, the controller may control the pressure of independently inflatable cells 1-24. For instance, the independently inflatable cells 1-24 may be inflated to individual pressure values or ranges, such as greater pressures for more distal cells and lower pressures for more proximal cells or vice versa. The independently inflatable cells 1-24 may be inflated to any pressure capable of use in compression therapy using a compression therapy device. For example, the independently inflatable cells 1-24 may be inflated to a pressure between and including about 5 mmHg (about 0.667 kPa) and about 150 mmHg (about 20.0 kPa). In some non-limiting examples, any one or more of independently inflatable cells 1-24 may be inflated to a pressure of about 5 mmHg (about 0.667 kPa), about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg (about 8.00 kPa), about 65 mmHg (about 8.67 kPa), about 70 mmHg (about 9.33 kPa), about 100 mmHg (about 13.3 kPa), about 120 mmHg (about 16.0 kPa), about 130 mmHg (about 17.3 kPa), about 150 mmHg (about 20.0 kPa), about 180 mmHg (about 24.0 kPa), and values and ranges between any two of these values (including endpoints).

The independently inflatable cells 1-24 may be inflated (e.g., deflated) from any of the pressures listed above to another lower pressure capable of use in compression therapy using the compression therapy device. For example, the independently inflatable cells 1-24 may be inflatable (e.g., deflatable) to a pressure between and including about 0 mmHg (about 0 kPa) and about 150 mmHg (about 20.0 kPa). In some non-limiting examples, any one or more of independently inflatable cells 1-24 may be inflated (e.g., deflated) to a pressure of about 5 mmHg (about 0.667 kPa), about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg (about 8.00 kPa), about 65 mmHg (about 8.67 kPa), about 70 mmHg (about 9.33 kPa), about 100 mmHg (about 13.3 kPa), about 120 mmHg (about 16.0 kPa), about 130 mmHg (about 17.3 kPa), about 140 mmHg (about 18.7 kPa), and values and ranges between any two of these values (including endpoints).

Although 24 cells 1-24 are depicted in FIG. 4, embodiments are not so limited as the compression garment 205 may include more or fewer cells according to some embodiments. For example, the compression garment 205 may include 3 independently inflatable cells, 4 independently inflatable cells, 5 independently inflatable cells, 6 independently inflatable cells, 10 independently inflatable cells, 15 independently inflatable cells, 20 independently inflatable cells, 30 independently inflatable cells, 40 independently inflatable cells, and ranges between any two of these values (including endpoints). The independently inflatable cells 1-24 may be arranged in various configurations, including axially, longitudinally, circumferentially, in various patterns, and combinations thereof. Additionally, the independently inflatable cells 1-24 may be any shape or curvature. For example, one or more of the independently inflatable cells 1-24 may be arcuate in shape when viewed in a plan view and may define arcuate side walls as measured from side to side, or axially. In one or more embodiments, one or more of the independently inflatable cells 1-24 may be rectangular in shape and may define straight side walls as measured axially.

The compression garment 205 may be configured to provide compression therapy, for example, as part of a lymphedema therapy. A physician or other medical professional may program and/or download to the controller one or more compression therapy protocols specifying the sequence of inflation/deflation of one or more of the independently inflatable cells 1-24 as well as the individual pressure of each cell (or group of cells). For example, the controller may be configured to implement the protocols illustrated in FIGS. 3A-3D, FIGS. 5A-5E, and/or variations thereof. In this manner, a patient may receive effective and individualized treatment for a medical condition, such as lymphedema or other edematous conditions.

The independently inflatable cells 1-24 of the compression garment 205 may be described as being controllable since the independently inflatable cells 1-24 are under control of a controller as described herein. Thus, the compression therapy system 200, using the controller, may be configured to provide, or deliver, compression therapy to an individual (e.g., a patient) wearing the compression garment 205 such that lymph flows throughout the body in desired directions (e.g., from the foot/feet towards the leg, trunk, and/or torso of the body). In other words, by controlling the independently inflatable cells 1-24 in a variety of different sequences (e.g., applying pressure in a predetermined manner), for example, lymph may flow generally from the foot/feet of the body towards the leg(s) and trunk of the body. The direction of lymph flow from the foot/feet towards the leg(s) and trunk of the body may provide relief to an individual by moving excess lymph from the foot/feet and leg(s), and ultimately, moving such lymph towards and into one or more regions of the trunk such as, e.g., the right axillary nodes located proximate a right under arm region and the left axillary nodes located proximate a left under arm region.

FIGS. 5A-5E depict illustrative compression therapy protocols according to some embodiments. One or more of the compression therapy protocols depicted in FIGS. 5A-5E may be used in any sequence and/or combination. In addition, one or more of the compression therapy protocols depicted in FIGS. 5A-5E may be used in sequence and/or combination with any other compression therapy protocol known to those having ordinary skill in the art.

Each of the protocols depicted in FIGS. 5A-5E provide lymphedema treatment for a limb such as a foot, leg, or arm, while simplifying the system and providing enhanced comfort to the user. More specifically, a manifold (e.g., manifold 72) may be configurable or operable to select a plurality of inflatable cells to receive fluid simultaneously and using only one valve/port (e.g., port 60). Further, the same plurality of inflatable cells may be vented to ambient air simultaneously and using only one exhaust valve/port. Thus, a group of cells may be inflated and deflated as a group using only one manifold port and using only one exhaust port. The garment thus does not require multiple ports and multiple tubes to inflate/deflate each cell individually, and the number of ports and tubes may be advantageously reduced. A reduction in the number of ports and tubes may advantageously reduce garment weight, complexity, and cost. For example, patients may don and doff the garment more easily. Moreover, it may be described that the illustrative systems, devices, and methods provide suitable lymphedema treatment that can be completed in an efficient and timely manner, due to the multi-wave pattern providing additional waves of treatment at a single time.

Referring now to FIG. 5A, an illustrative compression therapy protocol 504 or pattern for a compression garment (such as the compression garment 205 depicted in FIG. 4) having 24 cells 1-24 is shown. In some embodiments, cell 1 may be the distal cell (for example, closest to the foot or arm), cell 24 may be the proximal cell (for example, closest to the torso), and cells 2-23 may be intermediate cells. One having ordinary skill in the art would understood that the description that follows, although specifically referencing a 24-cell compression garment as depicted in FIG. 4, may similarly apply to compression garments having more or fewer cells and to compression garments used on body portions other than the extremities.

Each step 30, 31, 32, 33, 34, 35, 36, 37, 38, 39 may be active for a particular duration specified by the compression therapy protocol 504. In some embodiments, each step 30, 31, 32, 33, 34, 35, 36, 37, 38, 39 may last for the same duration. In some embodiments, one or more steps 30, 31, 32, 33, 34, 35, 36, 37, 38, 39 may last for different durations. For example, the step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 30, each of the cells 1-24 are at an initial pressure state. For example, each of the cells 1-24 may be deflated to 0 mmHg, or may be inflated to a low-pressure state at, for example, 5 mmHg. If the initial pressure state is 0 mmHg, a user may advantageously be able to don the compression garment without need to provide power to the compression garment system. If the initial pressure state is greater than 0 mmHg, a user may advantageously be able to more easily don the compression garment since the flexible garment will have some structure supplied to it in the form of pressurized fluid. Without pressurized fluid, the compression garment may be too flexible for some users to easily don the compression garment.

At step 31, the distal cell 1, the intermediate cell 4, and the intermediate cell 7 are inflated to a first pressure. The first pressure can vary based on the desired intensity (e.g., prescribed intensity) of the protocol 504. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso. At step 31, each of the cells 2, 3, 5, 6, and 8-24 may remain in their initial pressure state. Thus, the distal cell 1 and at least two of the plurality of proximal cells 2-24 are inflated to the first pressure during a first period of time, and each of the at least two of the plurality of proximal cells 2-24 inflated to the first pressure during the first period of time are not positioned adjacent the distal cell 1 or one another.

At step 32, the distal cell 1 and the intermediate cells 4 and 7 are inflated to a second pressure, and the intermediate cells 2, 5, and 8 are inflated to the first pressure. The cells 4, 5, 7, and 8 may each be referred to as a proximal cell or an intermediate cell. Thus, another at least three of the plurality of proximal cells 2-24 are inflated to the first pressure during a second period of time following expiration of the first period of time, and at least one of the at least three of the plurality of proximal cells 2-24 inflated to the first pressure during the second period of time are positioned either:
adjacent the distal cell 1, or adjacent the at least two of the plurality of proximal cells 2-24 inflated to the first pressure during the first period of time. Thus, the “wave” pattern is serial along adjacent cells.

In alternative embodiments, the at least one of the at least three of the plurality of proximal cells 2-24 inflated to the first pressure during the second period of time are not positioned adjacent the distal cell 1 or the at least two of the plurality of proximal cells 2-24 inflated to the first pressure during the first period of time. Instead, the “wave” pattern may skip over one cell, two cells, three cells, etc. Such skipping may advantageously allow for more efficient treatment times, and/or may provide further patient comfort.

At step 32, each of the cells 3, 6, and 9-24 may remain in their initial pressure state. If the step 32 is executed after step 31, the distal cell 1 and the intermediate cells 4 and 7 are deflated to the second pressure, and the intermediate cells 2, 5, and 8 are inflated to the first pressure. Each of the cells 2, 4, 5, 7, and 8 may be referred to as a proximal cell or an intermediate cell. The second pressure is less than the first pressure. In some embodiments, the second pressure can be about 0 mmHg (about 0 kPa), about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). At step 32, the protocol 504 can prevent lymphatic fluid from regressing back towards the distal region of the limb and the distal cell 1, while providing greater comfort to the user by relaxing the pressure applied to the distal cell 1 region of the limb (e.g., the foot). Thus, the distal cell 1 may be deflated to the second pressure during the second period of time. Further, the at least one of the plurality of proximal cells previously inflated to a first pressure during the first period of time may also be deflated to the second pressure during the second period of time.

At step 33, each of the distal cell 1 and the intermediate cells 2, 4, 5, 7, and 8 may remain inflated to the second pressure. For example, as shown in FIG. 5A, each of the distal cell 1 and the intermediate cells 4 and 7 remain inflated at the second pressure, and intermediate cells 2, 5, and 8 are deflated to the second pressure. The cells 3, 6, and 9 are inflated to the first pressure. The cells 3, 6, and 9 may be referred to as a proximal cell or an intermediate cell. At step 34, each of the cells 10-24 may remain in their initial pressure state. Thus, another at least two of the plurality of proximal cells 2-24 may be inflated to the first pressure during a third period of time following expiration of the second period of time, and each of the another at least two of the plurality of proximal cells 2-24 inflated to the first pressure during the third period of time are positioned adjacent one of the at least two of the plurality of proximal cells inflated to the first pressure during the second period of time.

At step 34, each of the distal cell 1 and the intermediate cells 2-9 may remain inflated to the second pressure. For example, as shown in FIG. 5A, each of the distal cell 1 and the intermediate cells 2-9 are deflated to or remain at the second pressure. At step 34, intermediate cells 10, 13, and 16 are inflated to the first pressure. Each of the cells 10, 13, and 16 may be referred to as a proximal cell or an intermediate cell. At step 34, each of the cells 11, 12, 14, 15, and 17-24 may remain in their initial pressure state.

At step 35, each of the intermediate cells 10, 13, and 16 may be inflated to the second pressure, and intermediate cells 11, 14, and 17 may be inflated to the first pressure. Distal cell 1 and intermediate cells 2-9 may remain at, inflate, or deflate to the second pressure. For example, as shown in FIG. 5A, each of the distal cell 1 and the intermediate cells 2-9 remain at the second pressure. If the step 35 is executed after step 34, the intermediate cells 10, 13, and 16 are deflated to the second pressure. Each of the cells 12, 15, and 18-24 may remain in their initial pressure state. Each of the cells 11, 14, and 17 may be referred to as a proximal cell or an intermediate cell.

At step 36, each of the intermediate cells 11, 14, and 17 may be inflated to the second pressure, and intermediate cells 12, 15, and 18 may be inflated to the first pressure. Distal cell 1 and intermediate cells 2-10, 13, and 16 may remain at, inflate, or deflate to the second pressure. For example, as shown in FIG. 5A, each of the distal cell 1 and the intermediate cells 2-10, 13, and 16 remain at the second pressure. If the step 35 is executed after step 34, the intermediate cells 10, 13, and 16 are deflated to the second pressure. Each of the cells 12, 15, and 18-24 may remain in their initial pressure state. Each of the cells 12, 15, and 18 may be referred to as a proximal cell or an intermediate cell.

At step 37, each of the intermediate cells 12, 15, and 18 may be inflated to the second pressure, and intermediate cells 19, 21, and 23 may be inflated to the first pressure. Distal cell 1 and intermediate cells 2-11, 13, 14, 16, and 17 may remain at, inflate, or deflate to the second pressure. For example, as shown in FIG. 5A, each of the distal cell 1 and the intermediate cells 2-11, 13, 14, 16, and 17 remain at the second pressure. If the step 37 is executed after step 36, the intermediate cells 12, 15, and 18 are deflated to the second pressure. Each of the cells 20, 22, and 24 may remain in their initial pressure state. Each of the cells 19, 21, and 23 may be referred to as a proximal cell or an intermediate cell.

At step 38, each of the intermediate cells 19, 21, and 23 may be inflated to the second pressure, and each of intermediate cells 20 and 22 and proximal cell 21 may be inflated to the first pressure. Distal cell 1 and intermediate cells 2-18 may remain at, inflate, or deflate to the second pressure. For example, as shown in FIG. 5A, each of the distal cell 1 and the intermediate cells 2-18 remain at the second pressure. If the step 38 is executed after step 37, the intermediate cells 19, 21, and 23 are deflated to the second pressure. Each of the cells 20, 22, and 23 may be referred to as a proximal cell or an intermediate cell.

At step 39, each of the cells 1-24 may remain at or be deflated to the initial pressure state. At step 39, intermediate cells 20 and 22 and proximal cell 24 are deflated to the initial pressure state. In one or more embodiments, the controller is further configured to cause the compression therapy apparatus to: deflate each of the plurality of independently inflatable cells 1-24 during a third period of time following expiration of the second period of time.

The steps 30, 31, 32, 33, 34, 35, 36, 37, 38, 39 can occur in the order shown in FIG. 5A, with earlier steps located at the top of the protocols 504, 505 (e.g., step 30), and later steps located at the bottom of the protocols 504, 505 (e.g., step 39). The steps can occur in the following order: step 30, followed by step 31, followed by step 32, followed by step 33, followed by step 34, followed by step 35, followed by step 36, followed by step 37, followed by step 38. After step 38, the protocol may proceed to step 39 and deflate all of the cells 1-24 to zero mmHg.

In some embodiments, each step can occur immediately after the previous step. For example, step 32 may occur immediately after step 31. In other embodiments, at least one step can be held for a period of time before the next step has begun. For example, step 31 may be held for some period of time before step 32 occurs. In some embodiments, the period of time between may vary between pairs of steps. For example, step 31 may be held for a first period of time before step 32 occurs, and step 32 may be held for a second period of time before step 33 occurs. The time between steps may be programmed into the controller or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 30, 31, 32, 33, 34, 35, 36, 37, 38, 39 may be active for any duration capable of operating according to some embodiments described herein. With respect to FIG. 5A, a cycle may be defined as a sequence of step 30, followed by step 31, followed by step 32, followed by step 33, followed by step 34, followed by step 35, followed by step 36, followed by step 37, followed by step 38, followed by step 39. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 1-24 may be deflated at step 39 for a duration after the completion of the compression therapy protocols 504, 505.

Referring now to FIG. 5B, an illustrative compression therapy protocol 506 or pattern for a compression garment (such as the compression garment 205 depicted in FIG. 4) having 24 cells 1-24 is shown. In some embodiments, cell 1 may be the distal cell (for example, closest to the foot or arm), cell 24 may be the proximal cell (for example, closest to the torso), and cells 2-23 may be intermediate cells. One having ordinary skill in the art would understand that the description that follows, although specifically referencing a 24-cell compression garment as depicted in FIG. 4, may similarly apply to compression garments having more or fewer cells and to compression garments used on body portions other than the extremities.

The main differences between protocol 504 and protocol 506 is that there is a four-wave pattern instead of a three-wave pattern of inflated cells, and there is an every-other pattern instead of a skipped cell pattern (which results in fewer protocol steps overall). A four-wave pattern may advantageously group more cells together than a three-wave pattern, reducing the number of valves and tubes required. An every-other pattern may advantageously allow a garment with three treatment regions (e.g., foot, calf, and thigh regions for a lower limb garment) to be performed with only six valves and six tubes, as opposed to the eight valves and tubes required for FIG. 5A. A garment may be designed with an optimal number and size of cells to treat a patient (e.g., larger cells may cover more area, smaller cells may provide more specific therapy, an arm garment may not require as many cells as a leg garment, etc.). The optimal garment may be paired with a specific protocol optimized for a patient's needs (e.g., a four-wave pattern may provide a more efficient protocol and reduce the number of valves and tubes needed compared to a three-wave pattern, but may be too large of a cell group for smaller patient anatomies).

Each step 30, 31, 32, 33, 34, 35, 36, 37 may be active for a particular duration specified by the compression therapy protocol 504. In some embodiments, each step 30, 31, 32, 33, 34, 35, 36, 37 may last for the same duration. In some embodiments, one or more steps 30, 31, 32, 33, 34, 35, 36, 37 may last for different durations. For example, the step may last for about 0 seconds to about 20 seconds. Non-limiting examples of a duration of each step may be about 0 seconds, 5 seconds, 10 seconds, 15 seconds, 20 seconds, or any value between any two of these values (including endpoints).

At step 30, each of the cells 1-24 are at an initial pressure state. For example, each of the cells 1-24 may be deflated to 0 mmHg, or may be inflated to a low-pressure state at, for example, 5 mmHg. If the initial pressure state is 0 mmHg, a user may advantageously be able to don the compression garment without need to provide power to the compression garment system. If the initial pressure state is greater than 0 mmHg, a user may advantageously be able to more easily don the compression garment since the flexible garment will have some structure supplied to it in the form of pressurized fluid. Without pressurized fluid, the compression garment may be too flexible for some users to easily don the compression garment.

At step 31, the distal cell 1, the intermediate cell 3, the intermediate cell 5, and the intermediate cell 7 are inflated to a first pressure. The first pressure can vary based on the desired intensity (e.g., prescribed intensity) of the protocol 506. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso. At step 31, each of the cells 2, 4, 6, and 8-24 may remain in their initial pressure state. Thus, the distal cell 1 and at least two of the plurality of proximal cells 2-24 are inflated to the first pressure during a first period of time, and each of the at least two of the plurality of proximal cells 2-24 inflated to the first pressure during the first period of time are not positioned adjacent the distal cell 1 or one another.

At step 32, the distal cell 1 and the intermediate cells 3, 5, and 7 are inflated to a second pressure, and the intermediate cells 2, 4, 6, and 8 are inflated to the first pressure. The cells 2, 4, 6, and 8 may each be referred to as a proximal cell or an intermediate cell. Thus, another at least three of the plurality of proximal cells 2-24 are inflated to the first pressure during a second period of time following expiration of the first period of time, and at least one of the at least three of the plurality of proximal cells 2-24 inflated to the first pressure during the second period of time are positioned either:
adjacent the distal cell 1, or adjacent the at least two of the plurality of proximal cells 2-24 inflated to the first pressure during the first period of time. Thus, the “wave” pattern is serial along adjacent cells.

In alternative embodiments, the at least one of the at least three of the plurality of proximal cells 2-24 inflated to the first pressure during the second period of time are not positioned adjacent the distal cell 1 or the at least two of the plurality of proximal cells 2-24 inflated to the first pressure during the first period of time. Instead, the “wave” pattern may skip over one cell, two cells, three cells, etc. (similar to the skipping illustrated in FIG. 5A). Such skipping may advantageously allow for more efficient treatment times, and/or may provide further patient comfort.

At step 32, each of the cells 9-24 may remain in their initial pressure state. If the step 32 is executed after step 31, the distal cell 1 and the intermediate cells 3, 5, and 7 are deflated to the second pressure, and the intermediate cells 2, 4, 6, and 8 are inflated to the first pressure. Each of the cells 2-8 may be referred to as a proximal cell or an intermediate cell. The second pressure may be less than the first pressure. In some embodiments, the second pressure can be about 0 mmHg (about 0 kPa), about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). At step 32, the protocol 504 can prevent lymphatic fluid from regressing back towards the distal region of the limb and the distal cell 1, while providing greater comfort to the user by relaxing the pressure applied to the distal cell 1 region of the limb (e.g., the foot). Thus, the distal cell 1 may be deflated to the second pressure during the second period of time. Further, the at least one of the plurality of proximal cells previously inflated to a first pressure during the first period of time may also be deflated to the second pressure during the second period of time.

At step 33, each of the distal cell 1 and the intermediate cells 2-8 may remain inflated to the second pressure. For example, as shown in FIG. 5B, each of the distal cell 1 and the intermediate cells 3, 5, and 7 remain inflated at the second pressure, and intermediate cells 2, 4, 6, and 8 are deflated to the second pressure. The cells 9, 11, 13, and 15 may be inflated to the first pressure. The cells 9, 11, 13, and 15 may be referred to as a proximal cell or an intermediate cell. At step 33, each of the cells 10, 12, 14, and 16-24 may remain in their initial pressure state. Thus, another at least two of the plurality of proximal cells 2-24 may be inflated to the first pressure during a third period of time following expiration of the second period of time, and at least one of of the another at least two of the plurality of proximal cells 2-24 inflated to the first pressure during the third period of time are positioned adjacent at least one of the at least two of the plurality of proximal cells inflated to the first pressure during the second period of time.

At step 34, each of the distal cell 1 and the intermediate cells 2-9 may remain inflated to the second pressure. For example, as shown in FIG. 5B, each of the distal cell 1 and the intermediate cells 2-9 are deflated to or remain at the second pressure. At step 34, intermediate cells 10, 12, 14, and 16 are inflated to the first pressure. Each of the cells 10, 12, 14, and 16 may be referred to as a proximal cell or an intermediate cell. At step 34, each of the cells 17-24 may remain in their initial pressure state.

At step 35, each of the intermediate cells 10, 12, 14, and 16 may be inflated to the second pressure, and intermediate cells 17, 19, 21, and 23 may be inflated to the first pressure. Distal cell 1 and intermediate cells 2-16 may remain at, inflate, or deflate to the second pressure. For example, as shown in FIG. 5B, each of the distal cell 1 and the intermediate cells 2-9, 11, 13, and 15 remain at the second pressure. If the step 35 is executed after step 34, the intermediate cells 10, 12, 14, and 16 are deflated to the second pressure. Each of the cells 18, 20, 22, and 24 may remain in their initial pressure state. Each of the cells 17, 19, 21, and 23 may be referred to as a proximal cell or an intermediate cell.

At step 36, each of the intermediate cells 17, 19, 21, and 23 may be inflated to the second pressure, and intermediate cells 18, 20, 22, and 24 may be inflated to the first pressure. Distal cell 1 and intermediate cells 2-17, 19, 21, and 23 may remain at, inflate, or deflate to the second pressure. For example, as shown in FIG. 5B, each of the distal cell 1 and the intermediate cells 2-16 remain at the second pressure. If the step 35 is executed after step 34, the intermediate cells 17, 19, 21, and 23 are deflated to the second pressure. Each of the cells 18, 20, 22, and 24 may be referred to as a proximal cell or an intermediate cell.

At step 37, each of the cells 1-24 may remain at or be deflated to the initial pressure state. At step 37, intermediate cells 18, 20, and 22 and proximal cell 24 are deflated to the initial pressure state. In one or more embodiments, the controller is further configured to cause the compression therapy apparatus to: deflate each of the plurality of independently inflatable cells 1-24 during a third period of time following expiration of the second period of time.

The steps 30, 31, 32, 33, 34, 35, 36, 37 can occur in the order shown in FIG. 5B, with earlier steps located at the top of the protocol 506 (e.g., step 30), and later steps located at the bottom of the protocols 506 (e.g., step 37). The steps can occur in the following order: step 30, followed by step 31, followed by step 32, followed by step 33, followed by step 34, followed by step 35, followed by step 36. After step 36, the protocol may proceed to step 37 and deflate all of the cells 1-24 to zero mmHg.

In some embodiments, each step can occur immediately after the previous step. For example, step 32 may occur immediately after step 31. In other embodiments, at least one step can be held for a period of time before the next step has begun. For example, step 31 may be held for some period of time before step 32 occurs. In some embodiments, the period of time between may vary between pairs of steps. For example, step 31 may be held for a first period of time before step 32 occurs, and step 32 may be held for a second period of time before step 33 occurs. The time between steps may be programmed into the controller or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 30, 31, 32, 33, 34, 35, 36, 37 may be active for any duration capable of operating according to some embodiments described herein. With respect to FIG. 5B, a cycle may be defined as a sequence of step 30, followed by step 31, followed by step 32, followed by step 33, followed by step 34, followed by step 35, followed by step 36, followed by step 37. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 1-24 may be deflated at step 37 for a duration after the completion of the compression therapy protocol 506.

In alternative embodiments (not shown), a three-wave pattern may be used instead of a four-wave pattern. A four-wave pattern may advantageously increase treatment efficiency and/or treatment area specificity, and may reduce the number of valves and tubes needed since more cells are grouped together. A three-wave pattern may advantageously be used with garments that include fewer cells overall, and may advantageously reduce the number of valves and tubes needed overall.

In further alternative embodiments (not shown), the pattern may change over time. For example, a four-wave pattern as shown in FIG. 5B may become a three-wave pattern, a two-wave pattern, a five-wave pattern, a one-wave pattern, etc., beginning at cell 9, or beginning at cell 17. Conversely, a three-wave pattern as shown in FIG. 5A may become a two-wave pattern, a four-wave pattern, a one-wave pattern, a five-wave pattern, etc., beginning at cell 10 or beginning at cell 19.

Referring now to FIG. 5C, an illustrative compression therapy protocol 507 or pattern for a compression garment (such as the compression garment 205 depicted in FIG. 4) having 16 cells 1-16 is shown. For example, the compression garment 205 depicted in FIG. 4 may only include 16 cells disposed along the entirety of the garment, or disposed proximate the distal end of the garment, etc. In some embodiments, cell 1 may be the distal cell (for example, closest to the foot or arm), cell 16 may be the proximal cell (for example, closest to the torso), and cells 2-15 may be intermediate cells. One having ordinary skill in the art would understand that the description that follows, although specifically referencing a 16-cell compression garment, may similarly apply to compression garments having more or fewer cells and to compression garments used on body portions other than the extremities.

Each step 30, 31, 32, 33, 34, 35, 36, 37, 38, 39 may be active for a particular duration specified by the compression therapy protocol 507. In some embodiments, each step 30, 31, 32, 33, 34, 35, 36, 37, 38, 39 may last for the same duration. In some embodiments, one or more steps 30, 31, 32, 33, 34, 35, 36, 37, 38, 39 may last for different durations, similar to those described with respect to protocols 504 and 506. Also similar to protocols 504 and 506, the shaded boxes symbolize cells inflated to the first pressure, and non-shaded boxes symbolize cells inflated to the second pressure. The main difference between protocols 504, 506 and protocol 507 is that there is a two-wave pattern instead of a three-wave or a four-wave pattern of inflated cells. An every-other pattern is used as illustrated in FIG. 5C.

As discussed above, a garment may be designed with an optimal number and size of cells to treat a patient (e.g., larger cells may cover more area, smaller cells may provide more specific therapy, an arm garment may not require as many cells as a leg garment, etc.). The optimal garment may be paired with a specific protocol optimized for a patient's needs (e.g., a two-wave pattern may provide a more specific target area coverage, but may increase the number of valves and tubes needed compared to a three-wave or a four-wave pattern).

At step 30, each of the cells 1-16 are at an initial pressure state. For example, each of the cells 1-16 may be deflated to 0 mmHg, or may be inflated to a low-pressure state at, for example, 5 mmHg. If the initial pressure state is 0 mmHg, a user may advantageously be able to don the compression garment without need to provide power to the compression garment system. If the initial pressure state is greater than 0 mmHg, a user may advantageously be able to more easily don the compression garment since the flexible garment will have some structure supplied to it in the form of pressurized fluid. Without pressurized fluid, the compression garment may be too flexible for some users to easily don the compression garment.

At step 31, the distal cell 1 and the intermediate cell 3 are inflated to a first pressure. The first pressure can vary based on the desired intensity (e.g., prescribed intensity) of the protocol 507. In some embodiments, the first pressure can be about 30 mmHg (about 4.00 kPa), about 35 mmHg (about 4.67 kPa), about 40 mmHg (about 5.33 kPa), about 45 mmHg (about 6.00 kPa), about 50 mmHg (about 6.67 kPa), about 55 mmHg (about 7.33 kPa), about 60 mmHg, and values and ranges between any two of these values (including endpoints). In one embodiment, the first pressure is 45 mmHg. Generally, the first pressure is large enough to provide sufficient enough pressure to the distal portion of a user limb to begin moving lymphatic fluid away from the distal end of the limb and towards the user torso. At step 31, each of the cells 2 and 4-16 may remain in their initial pressure state. Thus, the distal cell 1 and at least one of the plurality of proximal cells 2-24 are inflated to the first pressure during a first period of time, and the at least one of the plurality of proximal cells 2-24 inflated to the first pressure during the first period of time is not positioned adjacent the distal cell 1.

At step 32, the distal cell 1 and the intermediate cell 3 are inflated to a second pressure, and the intermediate cells 2 and 4 are inflated to the first pressure. The cells 2 and 4 may each be referred to as a proximal cell or an intermediate cell. Thus, another at least two of the plurality of proximal cells 2-24 are inflated to the first pressure during a second period of time following expiration of the first period of time, and at least one of the at least two of the plurality of proximal cells 2-24 inflated to the first pressure during the second period of time are positioned either: adjacent the distal cell 1, or adjacent the at least one of the plurality of proximal cells 2-24 inflated to the first pressure during the first period of time. Thus, the “wave” pattern is serial along adjacent cells.

In alternative embodiments, the at least one of the at least two of the plurality of proximal cells 2-24 inflated to the first pressure during the second period of time are not positioned adjacent the distal cell 1 or the at least one of the plurality of proximal cells 2-24 inflated to the first pressure during the first period of time. Instead, the “wave” pattern may skip over one cell, two cells, three cells, etc., similar to FIG. 5A. Such skipping may advantageously allow for more efficient treatment times, and/or may provide further patient comfort.

At step 32, each of the cells 5-16 may remain in their initial pressure state. If the step 32 is executed after step 31, the distal cell 1 and the intermediate cell 3 are deflated to the second pressure, and the intermediate cells 2 and 4 are inflated to the first pressure. The second pressure is less than the first pressure. In some embodiments, the second pressure can be about 0 mmHg (about 0 kPa), about 5 mmHg (about 0.667 kPa), about 10 mmHg (about 1.33 kPa), about 15 mmHg (about 2.00 kPa), about 20 mmHg (about 2.67 kPa), and values and ranges between any two of these values (including endpoints). The second pressure can be less than the first pressure by a reduction value. In some embodiment, the reduction value can be about 10 mmHg (about 1.33 kPa), about 15 mmHg (about 2.00 kPa), about 20 mmHg (about 2.67 kPa), about 25 mmHg (about 3.33 kPa), about 30 mmHg (about 4.00 kPa), about 35 mmHg (about 4.67 kPa), about 40 mmHg (about 5.33 kPa), and values and ranges between any two of these values (including endpoints). At step 32, the protocol 504 can prevent lymphatic fluid from regressing back towards the distal region of the limb and the distal cell 1, while providing greater comfort to the user by relaxing the pressure applied to the distal cell 1 region of the limb (e.g., the foot). Thus, the distal cell 1 may be deflated to the second pressure during the second period of time. Further, the at least one of the plurality of proximal cells previously inflated to a first pressure during the first period of time may also be deflated to the second pressure during the second period of time.

At step 33, each of the distal cell 1 and the intermediate cells 2-4 may remain inflated to the second pressure. For example, as shown in FIG. 5C, each of the distal cell 1 and the intermediate cell 3 remain inflated at the second pressure, and intermediate cells 2 and 4 are deflated to the second pressure. The cells 5 and 7 are inflated to the first pressure. The cells 5 and 7 may be referred to as a proximal cell or an intermediate cell. At step 33, each of the cells 6 and 8-16 may remain in their initial pressure state. Thus, another at least two of the plurality of proximal cells 2-24 may be inflated to the first pressure during a third period of time following expiration of the second period of time, and at least one of the another at least two of the plurality of proximal cells 2-24 inflated to the first pressure during the third period of time are positioned adjacent one of the at least two of the plurality of proximal cells inflated to the first pressure during the second period of time.

At step 34, each of the distal cell 1 and the intermediate cells 2-5 may remain inflated to the second pressure. For example, as shown in FIG. 5C, each of the distal cell 1 and the intermediate cells 2-5 are deflated to or remain at the second pressure. At step 34, intermediate cells 6 and 8 are inflated to the first pressure. Each of the cells 6 and 8 may be referred to as a proximal cell or an intermediate cell. At step 34, each of the cells 9-16 may remain in their initial pressure state.

At step 35, each of the intermediate cells 6 and 8 may be inflated to the second pressure, and intermediate cells 9 and 11 may be inflated to the first pressure. Distal cell 1 and intermediate cells 2-8 may remain at, inflate, or deflate to the second pressure. For example, as shown in FIG. 5C, each of the distal cell 1 and the intermediate cells 2-7 remain at the second pressure. If the step 35 is executed after step 34, the intermediate cells 6 and 8 are deflated to the second pressure. Each of the cells 10 and 12-16 may remain in their initial pressure state. Each of the cells 9 and 11 may be referred to as a proximal cell or an intermediate cell.

At step 36, each of the intermediate cells 9 and 11 may be inflated to the second pressure, and intermediate cells 10 and 12 may be inflated to the first pressure. Distal cell 1 and intermediate cells 2-8 may remain at, inflate, or deflate to the second pressure. For example, as shown in FIG. 5C, each of the distal cell 1 and the intermediate cells 2-8 remain at the second pressure. If the step 35 is executed after step 34, the intermediate cells 10 and 12 are deflated to the second pressure. Each of the cells 11 and 13-16 may remain in their initial pressure state. Each of the cells 10 and 12 may be referred to as a proximal cell or an intermediate cell.

At step 37, each of the intermediate cells 10 and 12 may be inflated to the second pressure, and intermediate cells 13 and 15 may be inflated to the first pressure. Distal cell 1 and intermediate cells 2-11 may remain at, inflate, or deflate to the second pressure. For example, as shown in FIG. 5C, each of the distal cell 1 and the intermediate cells 2-11 remain at the second pressure. If the step 37 is executed after step 36, the intermediate cells 10 and 12 are deflated to the second pressure. Each of the cells 14 and 16 may remain in their initial pressure state. Each of the cells 13 and 15 may be referred to as a proximal cell or an intermediate cell.

At step 38, each of the intermediate cells 13 and 15 may be inflated to the second pressure, and each of intermediate cell 14 and proximal cell 16 may be inflated to the first pressure. Distal cell 1 and intermediate cells 2-12 may remain at, inflate, or deflate to the second pressure. For example, as shown in FIG. 5C, each of the distal cell 1 and the intermediate cells 2-12 remain at the second pressure. If the step 38 is executed after step 37, the intermediate cells 13 and 15 are deflated to the second pressure. Each of the cells 14 and 16 may be referred to as a proximal cell or an intermediate cell.

At step 39, each of the cells 1-24 may remain at or be deflated to the initial pressure state. At step 39, intermediate cells 20 and 22 and proximal cell 24 are deflated to the initial pressure state. In one or more embodiments, the controller is further configured to cause the compression therapy apparatus to: deflate each of the plurality of independently inflatable cells 1-24 during a third period of time following expiration of the second period of time.

The steps 30, 31, 32, 33, 34, 35, 36, 37, 38, 39 can occur in the order shown in FIG. 5C, with earlier steps located at the top of the protocols 504, 505 (e.g., step 30), and later steps located at the bottom of the protocols 504, 505 (e.g., step 39). The steps can occur in the following order: step 30, followed by step 31, followed by step 32, followed by step 33, followed by step 34, followed by step 35, followed by step 36, followed by step 37, followed by step 38. After step 38, the protocol may proceed to step 39 and deflate all of the cells 1-24 to zero mmHg.

In some embodiments, each step can occur immediately after the previous step. For example, step 32 may occur immediately after step 31. In other embodiments, at least one step can be held for a period of time before the next step has begun. For example, step 31 may be held for some period of time before step 32 occurs. In some embodiments, the period of time between may vary between pairs of steps. For example, step 31 may be held for a first period of time before step 32 occurs, and step 32 may be held for a second period of time before step 33 occurs. The time between steps may be programmed into the controller or may be chosen by a health care worker at the time therapy occurs. In some non-limiting examples, a hold time between steps may be about 0 seconds to about 20 seconds. Non-limiting examples of a hold time between steps may be about 0 seconds, 5 seconds, 10 seconds, 15 seconds, 20 seconds, or any value between any two of these values (including endpoints). The steps 30, 31, 32, 33, 34, 35, 36, 37, 38, 39 may be active for any duration capable of operating according to some embodiments described herein. With respect to FIG. 5C, a cycle may be defined as a sequence of step 30, followed by step 31, followed by step 32, followed by step 33, followed by step 34, followed by step 35, followed by step 36, followed by step 37, followed by step 38, followed by step 39. Such a cycle may be repeated once, twice, 3 times, 5 times, 8 times, 10 times, 12 times, etc., or any number of times in a range between any two of these values (including endpoints). A cycle rest time may be defined as a time between cycles. In some non-limiting examples, a cycle rest time may last for about 2 seconds to about 20 seconds. Non-limiting examples of a cycle rest time may be about 0 seconds, 5 seconds, 10 seconds, 15 seconds, 20 seconds, or any value between any two of these values (including endpoints). In some embodiments, all of the cells 1-24 may be deflated at step 39 for a duration after the completion of the compression therapy protocols 504, 505.

Referring now to FIG. 5D, an illustrative compression therapy protocol 508 or pattern for a compression garment (such as the compression garment 205 depicted in FIG. 4) having 14 cells 1-14 is shown. For example, the compression garment 205 depicted in FIG. 4 may only include 14 cells disposed along the entirety of the garment, or disposed proximate the distal end of the garment, etc. In some embodiments, cell 1 may be the distal cell (for example, closest to the foot or arm), cell 14 may be the proximal cell (for example, closest to the torso), and cells 2-13 may be intermediate cells. One having ordinary skill in the art would understand that, although specifically referencing a 14-cell compression garment, the illustrated protocol may similarly apply to compression garments having more or fewer cells and to compression garments used on body portions other than the extremities.

Each step 30, 31, 32, 33, 34, 35, 36, 37, 38, 39 may be active for a particular duration specified by the compression therapy protocol 508. In some embodiments, each step 30, 31, 32, 33, 34, 35, 36, 37, 38, 39 may last for the same duration. In some embodiments, one or more steps 30, 31, 32, 33, 34, 35, 36, 37, 38, 39 may last for different durations, similar to those described with respect to protocols 504, 506, 507. Also similar to protocols 504, 506, 507, the shaded boxes symbolize cells inflated to the first pressure, and non-shaded boxes symbolize cells inflated to the second pressure. The main difference between protocols 504, 506, 507 and protocol 508 is that the three-wave pattern of inflated cells occurs serially throughout all of the cells 1-14 (i.e., the three-wave pattern does not “jump” from a first group of nine cells to a second group of nine cells and then to a third group of nine cells). A serial three-wave pattern may require more valves and tubes, and may advantageously allow for a continuous set of multiple waves to travel through the garment. A serial three-wave pattern may further advantageously increase the number of cells providing therapy at any given time, making the therapy more efficient without needing to break the garment up into distinct treatment regions. A disparate three-wave pattern as shown in FIG. 5A may advantageously allow for more efficient treatment to be provided with fewer valves and tubes. In alternative embodiments, a pattern may “jump” between groups of two cells, three cells (e.g., FIG. 5A), four cells, five cells, etc. By having fewer regions and fewer jumps between inflation cells, the number of valves and tubes can be reduced. For example, if a leg garment only had two treatment regions (e.g., foot and calf regions) and there was only one cell jump between each inflated pair, then the therapy could be delivered with only four valves and four air lines.

Referring now to FIG. 5E, an illustrative compression therapy protocol 509 or pattern for a compression garment (such as the compression garment 205 depicted in FIG. 4) having 11 cells 1-11 is shown. For example, the compression garment 205 depicted in FIG. 4 may only include 11 cells disposed along the entirety of the garment, or disposed proximate the distal end of the garment, etc. In some embodiments, cell 1 may be the distal cell (for example, closest to the foot or arm), cell 11 may be the proximal cell (for example, closest to the torso), and cells 2-10 may be intermediate cells. One having ordinary skill in the art would understood that, although specifically referencing a 11-cell compression garment, the illustrated protocol may similarly apply to compression garments having more or fewer cells and to compression garments used on body portions other than the extremities.

Each step 30, 31, 32, 33, 34, 35, 36, 37, 38, 39 may be active for a particular duration specified by the compression therapy protocol 509. In some embodiments, each step 30, 31, 32, 33, 34, 35, 36, 37, 38, 39 may last for the same duration. In some embodiments, one or more steps 30, 31, 32, 33, 34, 35, 36, 37, 38, 39 may last for different durations, similar to those described with respect to protocols 504, 506. Also similar to protocols 504-508, the shaded boxes symbolize cells inflated to the first pressure, and non-shaded boxes symbolize cells inflated to the second pressure. The main difference between protocol 508 and protocol 509 is that the serial pattern of inflated cells is a serial two-wave pattern instead of a serial three-wave pattern. A serial two-wave pattern may advantageously provide more efficient therapy than, for example, a one-wave pattern. In alternative embodiments not shown, a serial pattern may include one, two, three, four, more than four etc., cells in each wave. As the number of waves increases, the therapy will be more efficient at moving fluid in the limb. The serial pattern may not allow for the reduction of valves or tubes from the controller to the garment.

The compression therapy protocols 500-509 can be stored on the controller 52 in FIG. 1 (e.g., on computing apparatus 51). In some embodiments, the controller 52 can receive a modification request (e.g., from the user interface device 99) to modify at least one of the first pressure and the second pressure. The controller 52 may prevent modification of the first pressure and/or the second pressure if the request is not within predetermined ranges. For example, the first pressure may be required to be at least 30 mmHg and no more than 60 mmHg. As another example, the second pressure may be required to be at least 5 mmHg and no more than 20 mmHg.

It is to be understood that the first pressure and the second pressure being applied to the distal cell 505 as described with respect to the protocols 500-503 described with respect to the FIGS. 3A-3D (and similarly for the distal cell 1 as described with respect to protocols 504-509 described with respect to FIGS. 5A-5E) may be referred to as the first distal pressure and the second distal pressure. Further, it is to be understood that the second pressure being applied to any of the other cells 510-540 as described with respect to the protocols 500-503 described with respect to the FIGS. 3A-3D (and similarly for the cells 2-24 as described with respect to protocols 504-509 described with respect to FIGS. 5A-5E) may be referred to as the proximal pressure. Still further, the proximal pressure and the first distal pressure may have the same (i.e., equal) or different pressure values as or from one another.

Additionally, it to be understood that the systems, apparatus, and methods described herein may utilize more than a single distal cell that may be configured with the second pressure when the other cells are at the first pressure. For example, the two most distal cells may be reduced to the second distal pressure less than the initial, first distal pressure when the next cell is inflated to a proximal pressure (which may be the same, as in equal, or similar to the first distal pressure).

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Particular materials and dimensions thereof recited in the disclosed examples, as well as other conditions and details, should not be construed to unduly limit this disclosure. Although the subject matter has been described in language specific to structural features and/or methodological acts, it is to be understood that the subject matter defined in the appended claims is not necessarily limited to the specific features or acts described above. Rather, the specific features and acts described above are disclosed as representative forms of implementing the claims.

### EXEMPLARY EMBODIMENTS

Example 1: A therapeutic compression system comprising: a compression therapy apparatus operably couplable to a compression garment to provide compression therapy to a patient, the compression garment comprising a plurality of independently inflatable cells arranged to provide the compression therapy to a limb of the patient, the plurality of independently inflatable cells comprising a distal cell and a plurality of proximal cells arranged proximally to the distal cell; and a controller comprising one or more processors and operably coupled to the compression therapy apparatus, the controller configured to cause the compression therapy apparatus to: inflate the distal cell and at least one of the plurality of proximal cells to a first pressure during a first period of time, wherein the at least one of the plurality of proximal cells inflated to the first pressure during the first period of time is not positioned adjacent the distal cell; inflate another at least two of the plurality of proximal cells to the first pressure during a second period of time following expiration of the first period of time, wherein at least one of the at least two of the plurality of proximal cells inflated to the first pressure during the second period of time is positioned either adjacent the distal cell or adjacent the at least one of the plurality of proximal cells inflated to the first pressure during the first period of time; and inflate each of the distal cell and the at least one of the plurality of proximal cells previously inflated to the first pressure during the first period of time to a second pressure during the second period of time.

Example 2: The therapeutic compression system of any of Examples 1 and 3-42, wherein the controller is further configured to cause the compression therapy apparatus to inflate another at least two of the plurality of proximal cells to the first pressure during a third period of time following expiration of the second period of time, wherein at least one of the another at least two of the plurality of proximal cells inflated to the first pressure during the third period of time is positioned adjacent one of the at least two of the plurality of proximal cells inflated to the first pressure during the second period of time.

Example 3: The therapeutic compression system of any of Examples 1-2 and 4-42, wherein the controller is further configured to cause the compression therapy apparatus to inflate each of the at least two of the plurality of proximal cells previously inflated to the first pressure during the second period of time to the second pressure during the third period of time.

Example 4: The therapeutic compression system of any of Examples 1-3 and 5-42, wherein the second pressure is less than the first pressure and greater than zero mmHg.

Example 5: The therapeutic compression system of any of Examples 1-4 and 6-42, wherein the second pressure is less than the first pressure by at least a reduction value, wherein the reduction value is greater than or equal to 10 mmHg.

Example 6: The therapeutic compression system of any of Examples 1-5 and 7-42, wherein the first pressure is between 30 mmHg and 60 mmHg and the second pressure is between 5 mmHg and 20 mmHg.

Example 7: The therapeutic compression system of any of Examples 1-6 and 8-42, wherein the second pressure is less than or equal to 30 mmHg.

Example 8: The therapeutic compression system of any of Examples 1-7 and 9-42, wherein the controller is further configured to: receive a modification request to change at least one of the first pressure and the second pressure to a pressure value included in a plurality of predetermined pressure values; and change at least one of the first pressure and the second pressure in response to receiving the modification request, and wherein the controller is further configured to prevent modification of the second pressure.

Example 9: The therapeutic compression system of any of Examples 1-8 and 10-42, wherein each of the first pressure and the second pressure is 60 mmHg.

Example 10: The therapeutic compression system of any of Examples 1-9 and 11-42, wherein each of the first pressure and the second pressure is greater than or equal to 40 mmHg.

Example 11: The therapeutic compression system of any of Examples 1-10 and 12-42, wherein each of the first pressure and the second pressure is greater than or equal to 30 mmHg.

Example 12: The therapeutic compression system of any of Examples 1 -11 and 13-42, wherein each of the first pressure and the second pressure between 30 mmHg and 60 mmHg.

Example 13: The therapeutic compression system of any of Examples 1-12 and 14-42, wherein the first pressure is equal to the second pressure.

Example 14: The therapeutic compression system of any of Examples 1-13 and 15-42, wherein the therapeutic compression system further comprises the compression garment.

Example 15: The therapeutic compression system of any of Examples 1-14 and 16-42, wherein the controller is further configured to cause the compression therapy apparatus to: deflate each of the plurality of independently inflatable cells during a third period of time following expiration of the second period of time.

Example 16: The therapeutic compression system of any of Examples 1-15 and 17-42, wherein the controller is further configured to cause the compression therapy apparatus to: deflate each of the plurality of independently inflatable cells during a fourth period of time following expiration of the third period of time.

Example 17: The therapeutic compression system of any of Examples 1-16 and 18-42, wherein the compression garment comprises a proximal opening and a distal opening, and wherein the plurality of independently inflatable cells are arranged sequentially and adjacent to each other along the compression garment between the proximal opening and the distal opening.

Example 18: The therapeutic compression system of any of Examples 1-17 and 19-42, wherein the distal cell is immediately adjacent to the at least one of the plurality of proximal cells.

Example 19: A therapeutic compression method to provide compression therapy to a patient comprising: inflating a distal cell and at least one of a plurality of proximal cells of a compression garment comprising a plurality of independent inflatable cells to a first pressure during a first period of time, wherein the at least one of the plurality of proximal cells inflated to the first pressure during the first period of time is not positioned adjacent the distal cell, and wherein the plurality of proximal cells are arranged proximally to the distal cell; inflating another at least two of the plurality of proximal cells to the first pressure during a second period of time following expiration of the first period of time; and inflating each of the distal cell and the at least one of the plurality of proximal cells previously inflated to a first pressure during the first period of time to a second pressure during the second period of time.

Example 20: The therapeutic compression method of any of Examples 1-19 and 21-42, wherein at least one of the another at least two of the plurality of proximal cells inflated to the first pressure during the second period of time is positioned either adjacent the distal cell or adjacent the at least one of the plurality of proximal cells inflated to the first pressure during the first period of time.

Example 21: The therapeutic compression method of any of Examples 1-20 and 22-42, wherein at least one of the another at least two of the plurality of proximal cells inflated to the first pressure during the second period of time is not positioned either adjacent the distal cell or adjacent the at least one of the plurality of proximal cells inflated to the first pressure during the first period of time.

Example 22: The therapeutic compression method of any of Examples 1 -21 and 23-42, wherein the second pressure is less than the first pressure.

Example 23: The therapeutic compression method of any of Examples 1-22 and 24-42, further comprising inflating another at least two of the plurality of proximal cells to the first pressure during a third period of time following expiration of the second period of time.

Example 24: The therapeutic compression method of any of Examples 1-23 and 25-42, wherein at least one of the another at least two of the plurality of proximal cells inflated to the first pressure during the third period of time is positioned adjacent one of the at least two of the plurality of proximal cells inflated to the first pressure during the second period of time.

Example 25: The therapeutic compression method of any of Examples 1-24 and 26-42, wherein at least one of the another at least two of the plurality of proximal cells inflated to the first pressure during the third period of time is not positioned adjacent one of the at least two of the plurality of proximal cells inflated to the first pressure during the second period of time.

Example 26: The therapeutic compression method of any of Examples 1-25 and 27-42, wherein the second pressure is less than the first pressure.

Example 27: The therapeutic compression method of any of Examples 1-26 and 28-42, wherein the second pressure is less than the first pressure by at least a reduction value, wherein the reduction value is greater than or equal to 10 mmHg.

Example 28: The therapeutic compression method of any of Examples 1-27 and 29-42, wherein the first pressure is between 30 mmHg and 60 mmHg and the second pressure is between 0 mmHg and 20 mmHg.

Example 29: The therapeutic compression method of any of Examples 1-28 and 30-42, wherein the second pressure is less than or equal to 30 mmHg.

Example 30: The therapeutic compression method of any of Examples 1-29 and 31-42, further comprising: receiving a modification request to change at least one of the first pressure and the second pressure to a pressure value included in a plurality of predetermined pressure values; and changing at least one of the first pressure and the second pressure in response to receiving the modification request, and preventing modification of the second pressure.

Example 31: The therapeutic compression method of any of Examples 1-30 and 32-42, wherein each of the first pressure and the second pressure is 60 mmHg.

Example 32: The therapeutic compression method of any of Examples 1 -31 and 33-42, wherein each of the first pressure and the second pressure is greater than or equal to 40 mmHg.

Example 33: The therapeutic compression method of any of Examples 1-32 and 34-42, wherein each of the first pressure and the second pressure is greater than or equal to 30 mmHg.

Example 34: The therapeutic compression method of any of Examples 1-33 and 35-42, wherein each of the first pressure and the second pressure between 30 mmHg and 60 mmHg.

Example 35: The therapeutic compression method of any of Examples 1-34 and 36-42, wherein the first pressure is equal to the second pressure.

Example 36: The therapeutic compression method of any of Examples 1-35 and 37-42, wherein the therapeutic compression method is performed using a compression system comprising the compression garment.

Example 37: The therapeutic compression method of any of Examples 1-36 and 38-42, further comprising deflating each of the plurality of independently inflatable cells during a third period of time following expiration of the second period of time.

Example 38: The therapeutic compression method of any of Examples 1-37 and 39-42, further comprising deflating each of the plurality of independently inflatable cells during a fourth period of time following expiration of the third period of time.

Example 39: The therapeutic compression method of any of Examples 1-38 and 40-42, wherein the compression garment comprises a proximal opening and a distal opening, and wherein the plurality of independently inflatable cells are arranged sequentially and adjacent to each other along the compression garment between the proximal opening and the distal opening.

Example 40: The therapeutic compression method of any of Examples 1-39 and 41-42, wherein each of the at least two of the plurality of proximal cells is adjacent to the at least another two of the plurality of proximal cells.

Example 41: The therapeutic compression method of any of Examples 1-40 and 42, wherein the distal cell is immediately adjacent to the at least one of the plurality of proximal cells.

Example 42: A therapeutic compression system comprising: a compression therapy apparatus operably couplable to a compression garment to provide compression therapy to a patient, the compression garment comprising a plurality of independently inflatable cells arranged to provide the compression therapy to a limb of the patient, the plurality of independently inflatable cells comprising a distal cell and a plurality of proximal cells arranged proximally to the distal cell; and a controller comprising one or more processors and operably coupled to the compression therapy apparatus, the controller configured to cause the compression therapy apparatus to: inflate the distal cell and at least two of the plurality of proximal cells to a first pressure during a first period of time, wherein each of the at least two of the plurality of proximal cells inflated to the first pressure during the first period of time are not positioned adjacent the distal cell or one another; inflate another at least three of the plurality of proximal cells to the first pressure during a second period of time following expiration of the first period of time, wherein at least one of the at least three of the plurality of proximal cells inflated to the first pressure during the second period of time is positioned either adjacent the distal cell or adjacent one of the at least two of the plurality of proximal cells inflated to the first pressure during the first period of time; and inflate each of the distal cell and the at least two of the plurality of proximal cells previously inflated to the first pressure during the first period of time to a second pressure during the second period of time.

What is claimed:

1. A therapeutic compression system comprising:
a compression therapy apparatus operably couplable to a compression garment to provide compression therapy to a patient, the compression garment comprising a plurality of independently inflatable cells arranged to provide the compression therapy to a limb of the patient, the plurality of independently inflatable cells comprising a distal cell and a plurality of proximal cells arranged proximally to the distal cell; and
a controller comprising one or more processors and operably coupled to the compression therapy apparatus, the controller configured to cause the compression therapy apparatus to:
inflate the distal cell and at least one of the plurality of proximal cells to a first pressure during a first period of time, wherein the at least one of the plurality of proximal cells inflated to the first pressure during the first period of time is not positioned adjacent the distal cell;
inflate another at least two of the plurality of proximal cells to the first pressure during a second period of time following expiration of the first period of time, wherein at least one of the at least two of the plurality of proximal cells inflated to the first pressure during the second period of time is positioned either adjacent the distal cell or adjacent the at least one of the plurality of proximal cells inflated to the first pressure during the first period of time; and
inflate each of the distal cell and the at least one of the plurality of proximal cells previously inflated to the first pressure during the first period of time to a second pressure during the second period of time.

2. The therapeutic compression system of claim 1, wherein the controller is further configured to cause the compression therapy apparatus to inflate another at least two of the plurality of proximal cells to the first pressure during a third period of time following expiration of the second period of time, wherein at least one of the another at least two of the plurality of proximal cells inflated to the first pressure during the third period of time is positioned adjacent one of the at least two of the plurality of proximal cells inflated to the first pressure during the second period of time.

3. The therapeutic compression system of claim 2, wherein the controller is further configured to cause the compression therapy apparatus to inflate each of the at least two of the plurality of proximal cells previously inflated to the first pressure during the second period of time to the second pressure during the third period of time.

4. The therapeutic compression system of claim 1, wherein the second pressure is less than the first pressure.

5. The therapeutic compression system of claim 1, wherein the controller is further configured to:
receive a modification request to change at least one of the first pressure and the second pressure to a pressure value included in a plurality of predetermined pressure values; and
change at least one of the first pressure and the second pressure in response to receiving the modification request, and wherein the controller is further configured to prevent modification of the second pressure.

6. The therapeutic compression system of claim 1, wherein the first pressure is equal to the second pressure.

7. The therapeutic compression system of claim 1, wherein the controller is further configured to cause the compression therapy apparatus to:
deflate each of the plurality of independently inflatable cells during a third period of time following expiration of the second period of time.

8. The therapeutic compression system of claim 2, wherein the controller is further configured to cause the compression therapy apparatus to:
deflate each of the plurality of independently inflatable cells during a fourth period of time following expiration of the third period of time.

9. A therapeutic compression method to provide compression therapy to a patient comprising:
inflating a distal cell and at least one of a plurality of proximal cells of a compression garment comprising a plurality of independent inflatable cells to a first pressure during a first period of time, wherein the at least one of the plurality of proximal cells inflated to the first pressure during the first period of time is not positioned adjacent the distal cell, and wherein the plurality of proximal cells are arranged proximally to the distal cell;
inflating another at least two of the plurality of proximal cells to the first pressure during a second period of time following expiration of the first period of time; and
inflating each of the distal cell and the at least one of the plurality of proximal cells previously inflated to a first pressure during the first period of time to a second pressure during the second period of time.

10. The therapeutic compression method of claim 9, wherein at least one of the another at least two of the plurality of proximal cells inflated to the first pressure during the second period of time is positioned either adjacent the distal cell or adjacent the at least one of the plurality of proximal cells inflated to the first pressure during the first period of time.

11. The therapeutic compression method of claim 9, wherein at least one of the another at least two of the plurality of proximal cells inflated to the first pressure during the second period of time is not positioned either adjacent the distal cell or adjacent the at least one of the plurality of proximal cells inflated to the first pressure during the first period of time.

12. The therapeutic compression method of claim 9, wherein the second pressure is less than the first pressure.

13. The therapeutic compression method of claim 9, further comprising inflating another at least two of the plurality of proximal cells to the first pressure during a third period of time following expiration of the second period of time.

14. The therapeutic compression method of claim 13, wherein at least one of the another at least two of the plurality of proximal cells inflated to the first pressure during the third period of time is positioned adjacent one of the at least two of the plurality of proximal cells inflated to the first pressure during the second period of time.

15. The therapeutic compression method of claim 13, wherein at least one of the another at least two of the plurality of proximal cells inflated to the first pressure during the third period of time is not positioned adjacent one of the at least two of the plurality of proximal cells inflated to the first pressure during the second period of time.

16. The therapeutic compression method of claim 9, wherein the second pressure is less than the first pressure.

17. The therapeutic compression method of claim 9, further comprising:
receiving a modification request to change at least one of the first pressure and the second pressure to a pressure value included in a plurality of predetermined pressure values; and
changing at least one of the first pressure and the second pressure in response to receiving the modification request, and preventing modification of the second pressure.

18. The therapeutic compression method of claim 9, wherein the first pressure is equal to the second pressure.

19. The therapeutic compression method of claim 9, wherein each of the at least two of the plurality of proximal cells is adjacent to the at least another two of the plurality of proximal cells.

20. A therapeutic compression system comprising:
a compression therapy apparatus operably couplable to a compression garment to provide compression therapy to a patient, the compression garment comprising a plurality of independently inflatable cells arranged to provide the compression therapy to a limb of the patient, the plurality of independently inflatable cells comprising a distal cell and a plurality of proximal cells arranged proximally to the distal cell; and
a controller comprising one or more processors and operably coupled to the compression therapy apparatus, the controller configured to cause the compression therapy apparatus to:
inflate the distal cell and at least two of the plurality of proximal cells to a first pressure during a first period of time, wherein each of the at least two of the plurality of proximal cells inflated to the first pressure during the first period of time are not positioned adjacent the distal cell or one another;
inflate another at least three of the plurality of proximal cells to the first pressure during a second period of time following expiration of the first period of time, wherein at least one of the at least three of the plurality of proximal cells inflated to the first pressure during the second period of time is positioned either adjacent the distal cell or adjacent one of the at least two of the plurality of proximal cells inflated to the first pressure during the first period of time; and
inflate each of the distal cell and the at least two of the plurality of proximal cells previously inflated to the first pressure during the first period of time to a second pressure during the second period of time.
